(19) United States
(12) Patent Application Publication
(10) Pub. No.: US 2021/0050608 A1
(43) Pub. Date: Feb. 18, 2021

(54) HYDROGEN GENERATOR AND A METHOD FOR GENERATING HYDROGEN

(71) Applicant: H3 Dynamics Holdings Pte. Ltd., Singapore (SG)

(72) Inventors: Taras Wankewycz, Singapore (SG); Aidan Li, Singapore (SG); Xiaohu Zhang, Singapore (SG)

(21) Appl. No.: 16/967,024

(22) PCT Filed: Feb. 1, 2019
(86) PCT No.: PCT/SG2019/050060

§ 371 Date: Aug. 3, 2020

(30) Foreign Application Priority Data
Feb. 3, 2018 (SG) 10201800957X
Jul. 19, 2018 (GB) 1811769.7

(51) Int. Cl. H01M 8/065; B01J 19/24; B01J 19/00; H01M 8/0662; B01J 4/00; C01B 3/06; H01M 8/0432; H01M 8/04007

(52) U.S. Cl. CPC H01M 8/065; B01J 19/24; B01J 19/0013; H01M 8/0662; B01J 4/004; C01B 3/065; B01J 2219/00155; H01M 8/04067; B01J 2204/007; B01J 2204/002; B01J 2219/00162; B01J 2219/00063; H01M 8/0432

(57) ABSTRACT

A hydrogen generator can include, in some aspects, a reaction chamber configured to contain a reagent; a supply water tank; water conduit tubing provided inside the reaction chamber, the water conduit tubing including a water conduit tubing inlet being fluidically connected to the supply water tank and a water conduit tubing outlet; a water dispenser provided inside the reaction chamber, the water dispenser including a water dispenser inlet being fluidically connected to the water conduit tubing outlet and a surface with a plurality of water outlet channels; a water pump; an electric power supply; a controller adapted to activate the water pump for transferring water through the hydrogen generator for interacting with the reagent in the reaction chamber to generate hydrogen gas, and a hydrogen collector provided inside the reaction chamber, the hydrogen collector including a surface with a plurality of gas inlet channels for receiving the hydrogen gas.

The technical field generally relates to hydrogen generators, and more particularly relates to hydrogen generators based on a chemical reaction.

GB 970420 shows a system that produces hydrogen from an exothermic reaction of magnesium hydride with water, wherein pressure of the hydrogen is sensed to control an operation of a pump.

US 2008/0075987 A1 describes another hydrogen generator which also is controlled on demand by controlling the amount of steam injected into the reaction chamber. The amount of steam reacting with the magnesium hydride is proportional to the amount of hydrogen gas generated. For start-up, electric heaters in some sort of boiler are used. The water is vaporized in the boiler by heat that is recovered from the exothermic reaction in the reaction chamber.

It is an object of this application to provide an improved hydrogen generator and an improved method for generating hydrogen.

A hydrogen generator with a water conduit tubing that serves as a water transport medium and as a water heater is described below.

The application provides a hydrogen generator that includes a reaction chamber, a supply water tank, at least one water conduit tubing, at least one water dispenser, a water pump, an electric power supply, a controller, and at least one hydrogen collector.

The reaction chamber is used for containing a chemical reagent, such as magnesium hydride.

The water conduit tubing includes a water conduit tubing inlet being fluidically connected to the supply water tank and a water conduit tubing outlet.

The water dispenser includes a water dispenser inlet being fluidically connected to the water conduit tubing outlet, and a surface with a plurality of water outlet channels.

The water conduit tubing, and the water dispenser are provided inside the reaction chamber.

These connections allow water to flow, from the supply water tank, to the water conduit, to the water dispenser, and to an inner part of the reaction chamber.

The controller is adapted to activate the water pump for transferring water from the supply water tank, to the water conduit tubing, to inside of the water dispenser, to the water outlet channels, and to inside of the reaction chamber. The water is intended for interacting with the reagent inside the reaction chamber to generate hydrogen gas.

The hydrogen collector includes a surface with a plurality of gas inlet channels for receiving the generated hydrogen gas. The hydrogen collector is provided inside the reaction chamber.

The generated hydrogen gas then flows through the gas inlet channels, and to inside of the hydrogen collector.

Furthermore, the water conduit tubing comprises an elongated electrically conductive material.

The controller is further adapted to activate the electric power supply for providing an electric current to the water conduit tubing being provided in the reaction chamber such that the tubing serves as a water transport medium and water heater for increasing a temperature of water in the water conduit tubing and the reagent inside the reaction chamber. The water conduit in the reaction chamber acts to both transport water and to heat the water that is being transported. The provided electric current in turns acts to increase temperature of the water in the water conduit tubing and also increase temperature of the chemical reagent in the reaction chamber.

The heated water then flows to the inside of the water dispenser and out of the water dispenser. The water and the reagent are heated such that they are hot enough to interact with each other.

A portion of the reaction chamber can be electrically conductive, such that an electrical current flow through said portion of the reaction chamber and through the water conduit tubing for increasing a temperature of the water in the water conduit tubing while transporting the water in the water conduit tubing.

A hydrogen generator with a water dispenser heater is described below.

The application provides another hydrogen generator. The hydrogen generator includes a reaction chamber, a supply water tank, at least one water conduit tubing, at least one water dispenser, a water pump, an electric power supply, a controller, and at least one hydrogen collector.

The reaction chamber is used for containing a chemical reagent, such as a metal hydride.

The water conduit tubing includes a water conduit tubing inlet being fluidically connected to the supply water tank and a water conduit tubing outlet.

The water dispenser includes a water dispenser inlet being fluidically connected to the water conduit tubing outlet, and a surface with a plurality of water outlet channels.

The water conduit tubing and the water dispenser are provided inside the reaction chamber.

The controller is adapted to activate the water pump for transferring water from the supply water tank, to the at least one water conduit tubing, to the at least one water dispenser, and to the reaction chamber for interacting with the reagent to generate hydrogen gas.

The hydrogen collector includes a surface with a plurality of gas inlet channels for receiving the generated hydrogen gas.

The hydrogen collector is also provided inside the reaction chamber.

The water dispenser further comprises a heater for heating water in the water dispenser. The heating is done such that the water reaches a predetermined interaction temperature, wherein the water later flows to the reaction chamber and the water is hot enough to interact with the reagent in the reaction chamber in order to generate hydrogen gas.

The device provides another way of heating water that later flows to the reaction chamber.

The water conduit tubing can include a coiled tube that surrounds the water dispenser. This arrangement allows heat generated from the exothermic interaction between water and the reagent to heat the water coil. In detail, the coiled tube of the water conduit tubing serves to supply water to the water dispenser. The water then flows out of the water dispenser to interact with the reagent, which is contained in the reaction chamber. This interaction produces hydrogen gas and also generates heat. The coiled tube, which surrounds the water dispenser, then acts to capture this heat. This in turn acts to heat the water in the coiled tube. The heat then acts to trigger and accelerate the interaction between the water and the reagent.

The hydrogen generator can include a plurality of water dispensers, although it can also include just one water dispenser.

Similarly, the hydrogen generator can include a plurality of hydrogen collectors, although it can also include just one hydrogen collector.

In one implementation, the hydrogen generator includes one water dispenser and five hydrogen collectors being placed symmetrically around the water dispenser.

The hydrogen collectors are often placed symmetrically around a corresponding water dispenser for effective collection of hydrogen gas.

The hydrogen generator can also include a pressure sensor and a temperature sensor. The pressure sensor is used for measuring pressure of hydrogen gas, the pressure sensor can be positioned inside the reaction chamber or be positioned at a gas outlet of the reaction chamber. The temperature sensor is used for measuring temperature in the reaction chamber.

The reaction chamber can include a housing that comprises a thermal insulating material. This thermal insulating material does not permit heat to dissipate from the reaction chamber. This is useful when dissipation of heat would not allow the reaction chamber to operate within a predetermined operating temperature.

Alternatively, the reaction chamber can also include a housing that comprises a thermal conductive material. This thermal conductive material allows heat to dissipate from the reaction chamber. This is useful when the dissipation of heat would allow the reaction chamber to operate within a predetermined operating temperature.

The reaction chamber can be provided with a housing that has a doughnut shape. The doughnut shape refers to a ring shape with a hollow centre part. The hollow centre part allows an inner part of the housing be exposed to external air, thereby allowing the external air to cool the hollow centre part. In use, this especially useful, when the reaction chamber is very hot.

The reaction chamber can also include a fan that is provided in a central hollow part of the doughnut shape of the housing for cooling the reaction chamber. The fan refers to a device for generating a stream of air. The stream of air then acts to reduce a temperature of an inner part of the reaction chamber.

In use, the reaction chamber often has an elevated temperature. The fan can then be used to control the temperature of the reaction chamber, thereby allow the reaction chamber to operate within a predetermined operating temperature range.

An improved energy power supply device that includes the above-mentioned hydrogen generator and includes a fuel cell module is described below.

The application provides the above hydrogen generator and a fuel cell module.

The hydrogen generator also includes a cooling coil and a buffer tank.

The cooling coil is used for receiving hydrogen gas from a reaction chamber. The hydrogen gas often contains water vapour. The cooling coil then acts for reducing temperature of the hydrogen gas and for reducing temperature of any water vapour that is present in the hydrogen gas. This often converts the water vapour to water droplets. In the words, the water vapour is converted to liquid water.

The buffer tank later receives the hydrogen gas, which often contains water, from the cooling coil. The buffer tank then allows the hydrogen gas to be separated from any water that is mixed with the hydrogen gas. The buffer tank often allows the hydrogen gas to rise to an upper chamber of the buffer tank while allowing the water to descent to a lower chamber of the buffer tank.

The buffer tank can be provided with a water level sensor and a water control valve. The water control valve is located between the buffer tank and the water tank. When the controller receives a reading from the water level sensor to indicate that water level of the buffer tank reaches a predetermined height, the controller then actuates the water control valve to an open position, for purging the water in the buffer tank into the water tank. This purging acts to recycle water from the buffer tank into the water tank to reduce water consumption in the system and, as a result, also reduce the system weight.

The fuel cell module afterward receives the hydrogen gas from the buffer tank, wherein the fuel cell module converts the hydrogen gas to electrical energy. This electrical energy can later be transmitted to an electrical load, such as an electric motor. The electrical load then consumes the electrical energy.

An improved energy power supply device with an impurity filter is described below.

The application provides an energy power supply device that includes a hydrogen generator and a fuel cell module. The hydrogen generator includes a supply water tank, a reaction chamber, a water pump, a cooling coil, and a buffer tank.

The water pump serves to transfer water from the supply water tank to the reaction chamber. The reaction chamber is used for containing a chemical reagent, which is intended for interacting with the water to generate hydrogen gas. This hydrogen gas often contains water vapour.

The cooling coil acts to receive the hydrogen gas with any water vapour from the reaction chamber and then acts to reduce temperature of the hydrogen gas and temperature of the water vapour.

The buffer tank acts for separating the hydrogen gas from any water that is mixed with the hydrogen gas.

The fuel cell module then converts the hydrogen gas to electrical energy,

The energy power supply device further comprises an impurity filter to remove impurities or foreign particles from the hydrogen gas. The impurity filter can be placed between the buffer tank and the fuel cell module, although other positions are also possible.

An improved energy power supply device, which includes a cooling coil that is cooled by a fan is described below.

The application provides an energy power supply device that includes a hydrogen generator and a fuel cell module. The hydrogen generator includes a supply water tank, a reaction chamber, a water pump, a cooling coil, and a buffer tank, which are described above.

The hydrogen generator further comprises a fan. The fan is often placed near to the cooling coil. The fan acts for reducing temperature of the cooling coil.

An improved energy power supply device, which includes a cooling coil that is placed in a water tank of the energy power supply device is described below.

The application provides an energy power supply device that includes a hydrogen generator and a fuel cell module. The hydrogen generator includes a supply water tank, a reaction chamber, a water pump, a cooling coil, and a buffer tank, which are described above.

The cooling coil is positioned in the supply water tank. The water tank is used for holding water, which also acts to cool the cooling coil.

An improved energy power supply device, which includes a cooling coil, a buffer tank, and a water pump of the energy power supply device. The cooling coil, the buffer tank, and the water pump are placed in a water tank of the energy power supply device is described below.

The application provides an energy power supply device that includes a hydrogen generator and a fuel cell module. The hydrogen generator includes a supply water tank, a reaction chamber, a water pump, a cooling coil, and a buffer tank, which are described above.

The cooling coil, the buffer tank, and the water pump are provided inside the supply water tank. This provides a compact structure which takes up a small space. This is useful especially, when the energy power supply device is portable.

An improved energy power supply device, which includes a buffer tank and a supply water tank, wherein both buffer tank and the supply water tank are provided by a single water tank is described below.

The application provides an energy power supply device that includes a hydrogen generator and a fuel cell module. The hydrogen generator includes a supply water tank, a reaction chamber, a water pump, a cooling coil, and a buffer tank, which are described above.

Herein, the buffer tank and the supply water tank are provided by a single integrated tank. The integrated tank acts to reduce number of parts needed to build the energy power supply device, which in turn acts to reduce cost of building the energy power supply device.

The integrated tank also provides a benefit in that pressure of the generated hydrogen gas in the integrated tank also serves to help to push water in the integrated tank back to the reaction chamber. This is especially helpful when the resistant pressure against which the water pump transfers the water into the reaction chamber is very high.

The application also provides an improved energy power supply device, which includes a connector for removably attaching a hydrogen generator to a fuel cell module.

The energy power supply device includes a hydrogen generator and a fuel cell module. The hydrogen generator includes a supply water tank, a reaction chamber, a water pump, a cooling coil, and a buffer tank, which are described above.

The energy power supply device also includes a connector for removably attaching the hydrogen generator to the fuel cell module.

The hydrogen generator contains water and a chemical reagent for interacting with the water to produce hydrogen gas. The water and/or the reagent may be spent after a predetermined time of use. The connector then allows a user to change easily the hydrogen generator. This is useful, especially when the energy power supply device is in the field.

In one implementation, the connector refers to a press-fit connector. The press-fit connector can include at least one insertion member and at least one corresponding receiving member. The at least one corresponding receiving member is intended for attaching to the at least one insertion member so that the at least one insertion member and the at least one corresponding receiving member are fastened easily to each other by friction. The at least one insertion member and the at least one corresponding receiving member can also be easily separated by pulling them away from each other with a small force.

The insertion member can be removably attached to the fuel cell module while the corresponding receiving member can be removably attached to the hydrogen generator.

Alternately, the insertion member can be removably attached to the hydrogen generator and the at least one corresponding receiving member can be removably attached to the fuel cell module.

In a special implementation, the at least one insertion member further comprises a fluidic channel. The fluidic channel acts to allow hydrogen gas to be transmitted from the hydrogen generator to the fuel cell module.

The application also provides an improved energy power supply device, which includes a connector for removably attaching a water tank to a reaction chamber.

The energy power supply device includes a hydrogen generator and a fuel cell module. The hydrogen generator includes a supply water tank, a reaction chamber, a water pump, a cooling coil, and a buffer tank, which are described above.

The water tank is used for containing and for supply water to reaction chamber. The water may be spent after a predetermined time of use. The connector then allows a user to change easily the water tank.

The application also provides an improved energy power supply device, which includes a fan for cooling a fuel cell module.

The energy power supply device includes a hydrogen generator and a fuel cell module. The hydrogen generator includes a supply water tank, a reaction chamber, a water pump, a cooling coil, and a buffer tank, which are described above.

The energy power supply device also includes a fan for cooling the fuel cell module. The fan is often near to the fuel cell module.

The application also provides an improved energy power supply device, which includes a housing for enclosing parts of the energy power supply device. The housing includes one or more opening for allowing air into the housing for cooling parts of the energy power supply device.

The energy power supply device includes a hydrogen generator and a fuel cell module. The hydrogen generator includes a supply water tank, a reaction chamber, a water pump, a cooling coil, and a buffer tank, which are described above.

The energy power supply device also includes a housing for enclosing the hydrogen generator and the fuel cell module. The housing includes one or more openings for drawing external air into the housing in order to cool the cooling coil and/or the reaction chamber.

The exemplary embodiments will hereinafter be described in conjunction with the following drawing figures, wherein like numerals denote like elements, and wherein

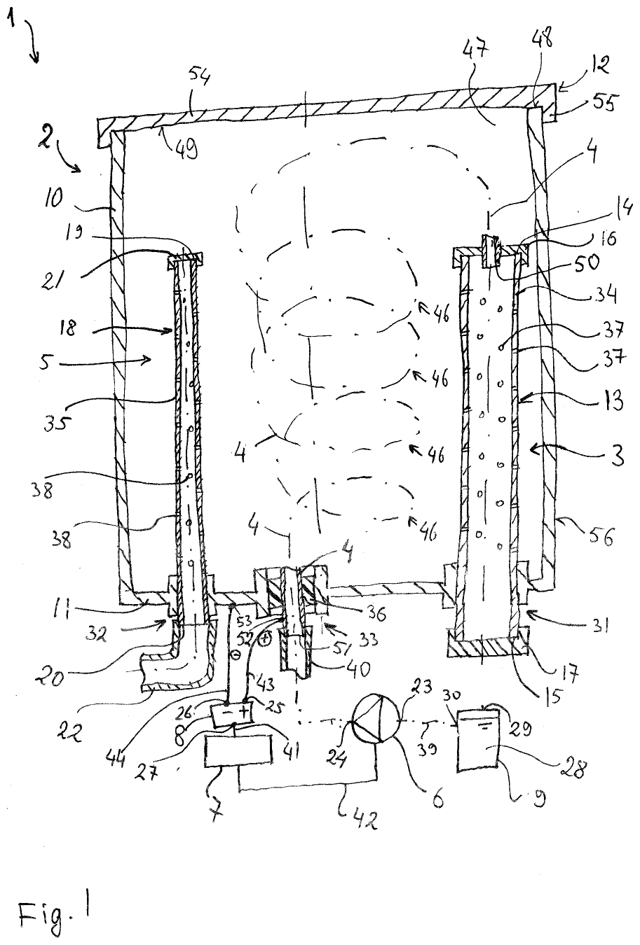

FIG. 1 illustrates a simplified schematic view of a hydrogen generator,

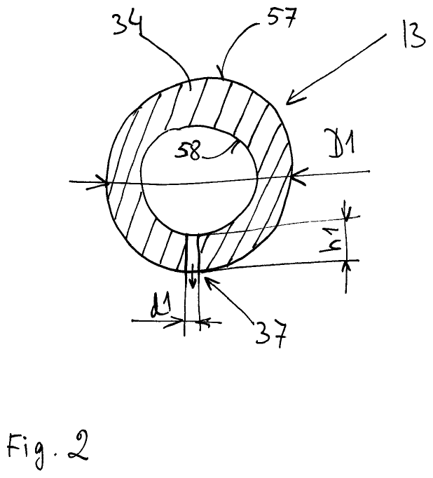

FIG. 2 illustrates a cross-sectional view of a tubular body of a water supply tubing of the hydrogen generator of FIG. 1, which acts a water dispenser,

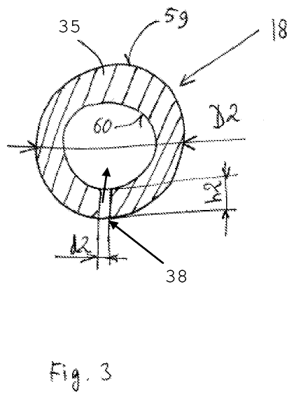

FIG. 3 illustrates a cross-sectional view of a tubular body water of the hydrogen collector of FIG. 1,

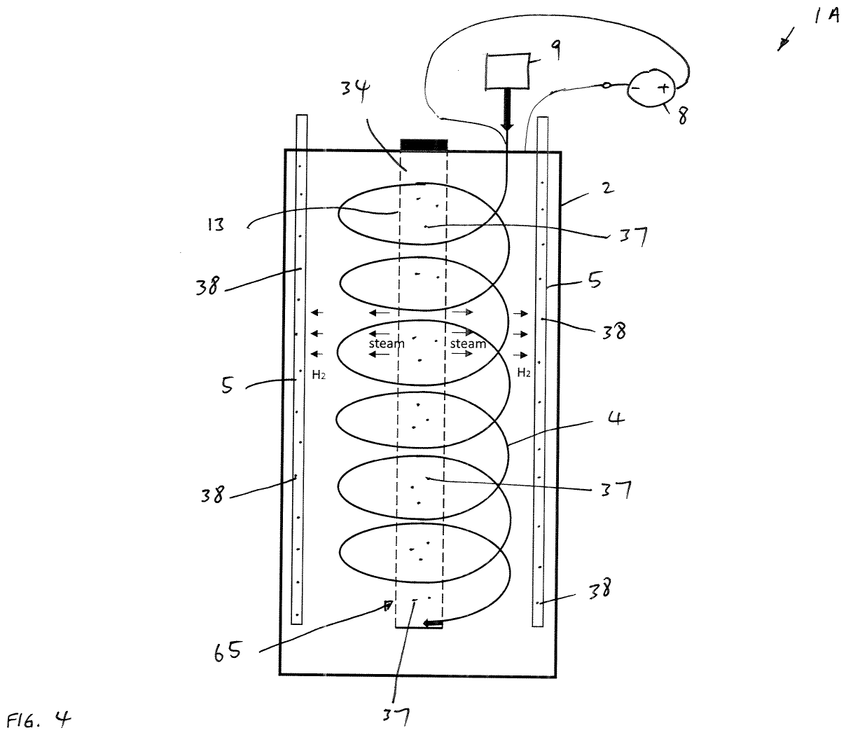

FIG. 4 illustrates a further hydrogen generator, which a variant of the hydrogen generator of FIG. 1,

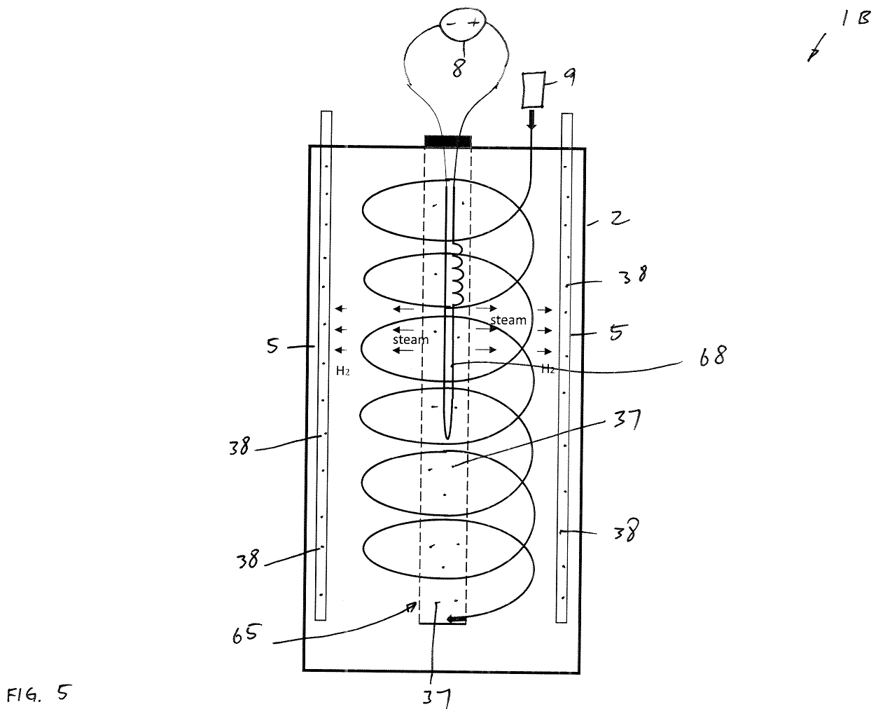

FIG. 5 illustrates another hydrogen generator, which includes a heater for a water dispenser,

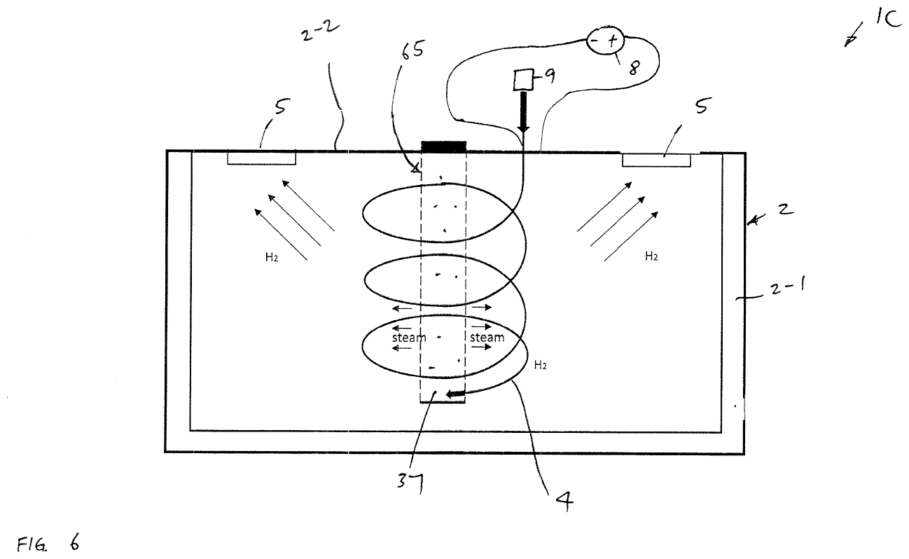

FIG. 6 illustrates another hydrogen generator, which includes two hydrogen collectors being arranged perpendicular to a water dispenser,

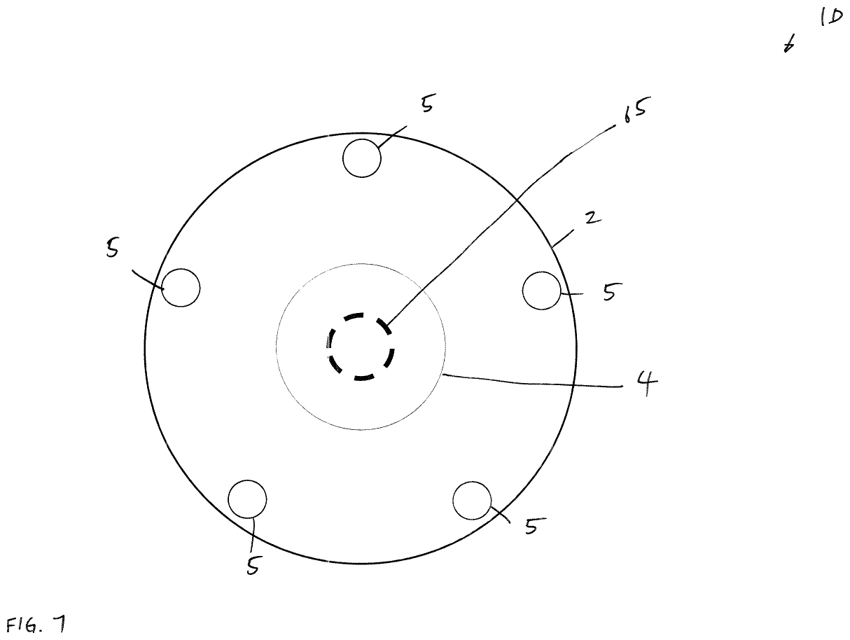

FIG. 7 illustrates a further hydrogen generator, which includes one water dispenser with several hydrogen collectors,

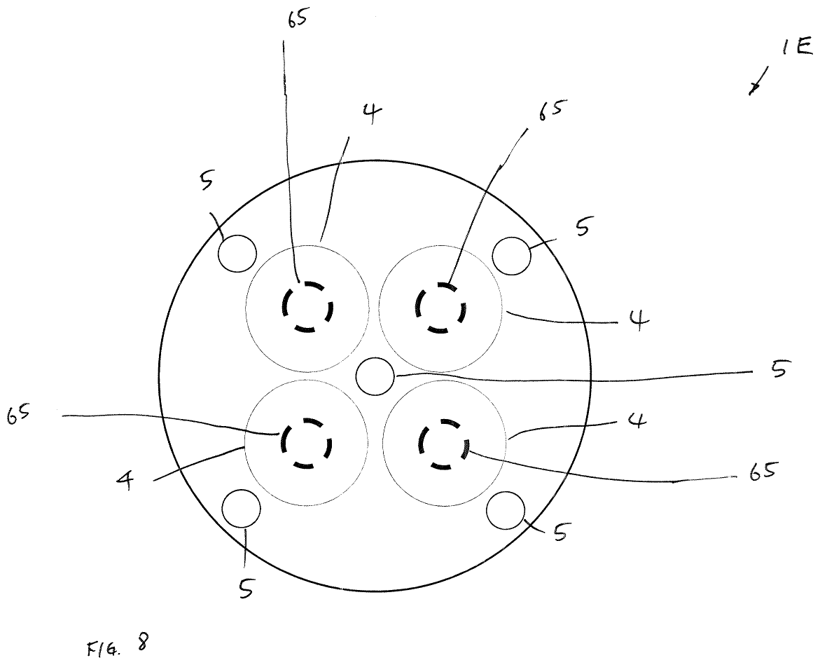

FIG. 8 illustrates a further hydrogen generator, which includes several water dispensers with several corresponding hydrogen collectors,

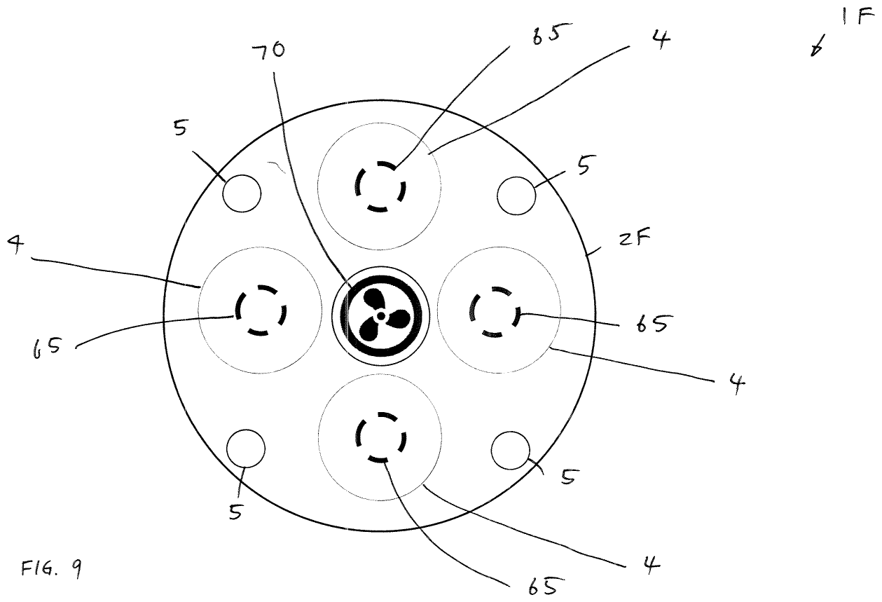

FIG. 9 illustrates a further hydrogen generator, which includes a reaction chamber with a doughnut-shaped housing,

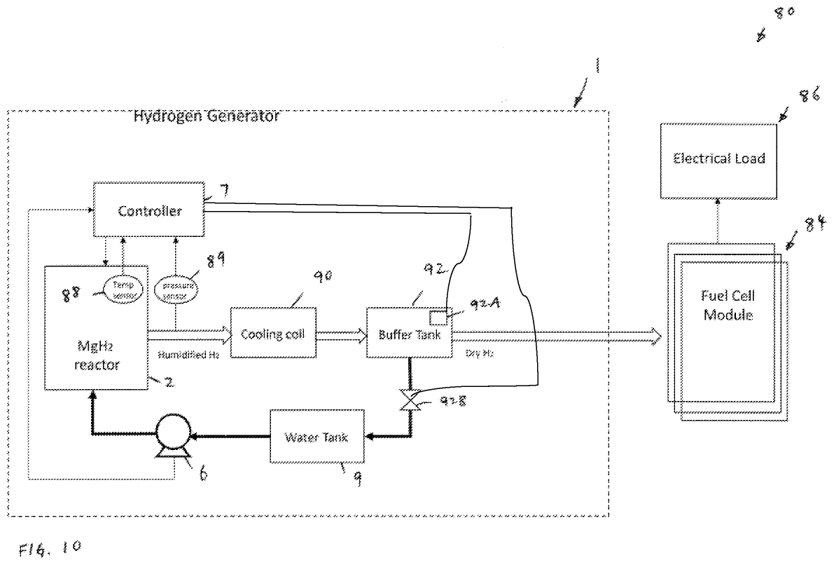

FIG. 10 illustrates an energy power supply device that includes a hydrogen generator of FIG. 1 or 4,

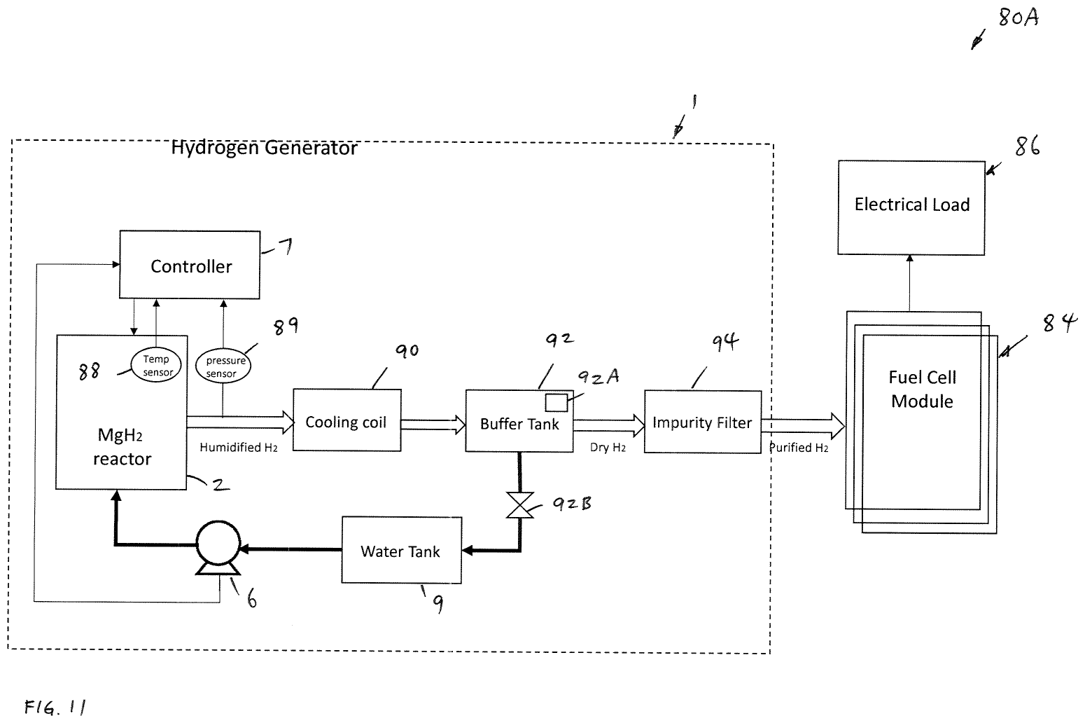

FIG. 11 illustrates a variant of the energy power supply device of FIG. 10, which includes an impurity filter,

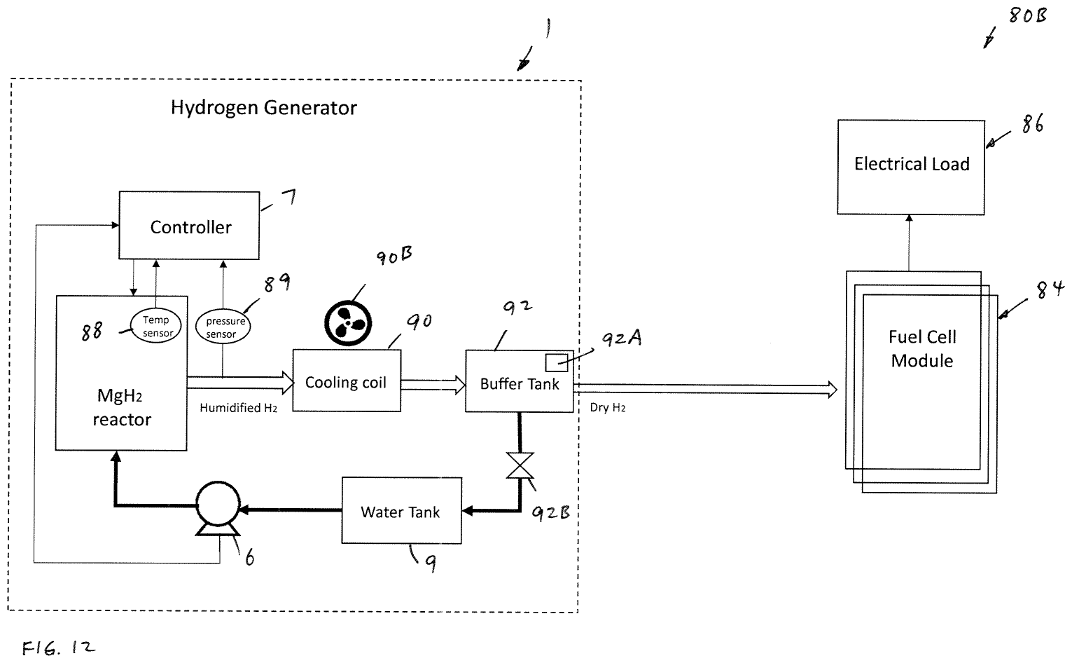

FIG. 12 illustrates a further variant of the energy power supply device of FIG. 10, which includes a fan for reducing temperature of a cooling coil,

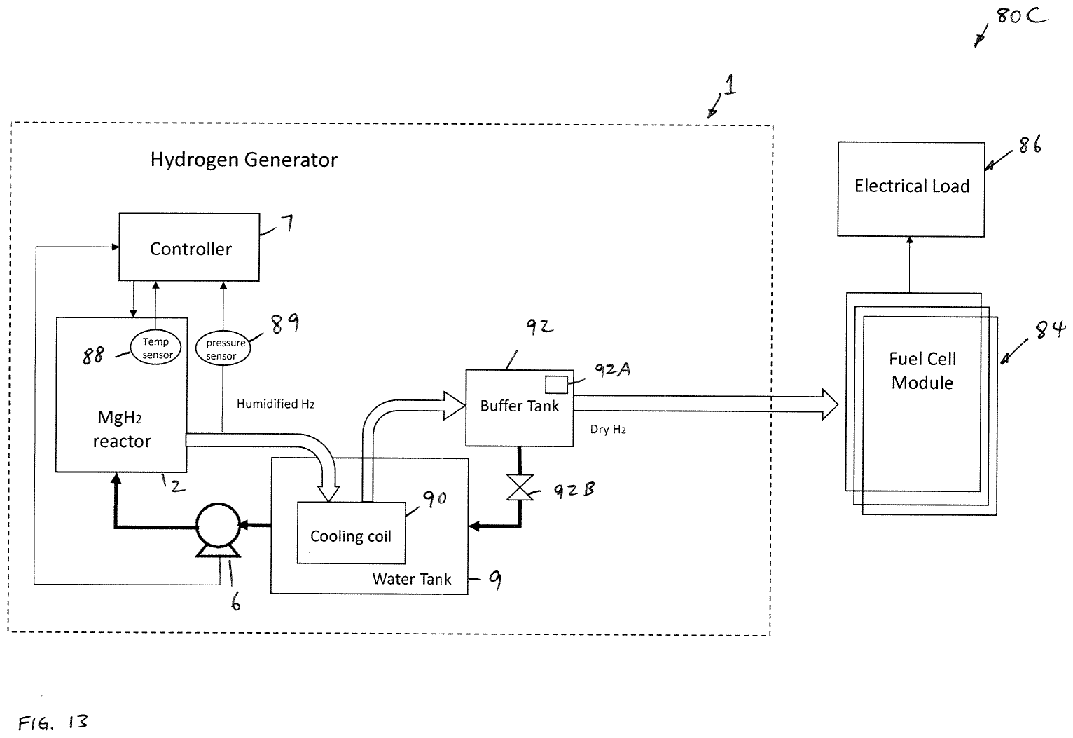

FIG. 13 illustrates another variant of the energy power supply device of FIG. 10, which includes a cooling coil that is positioned inside a water tank,

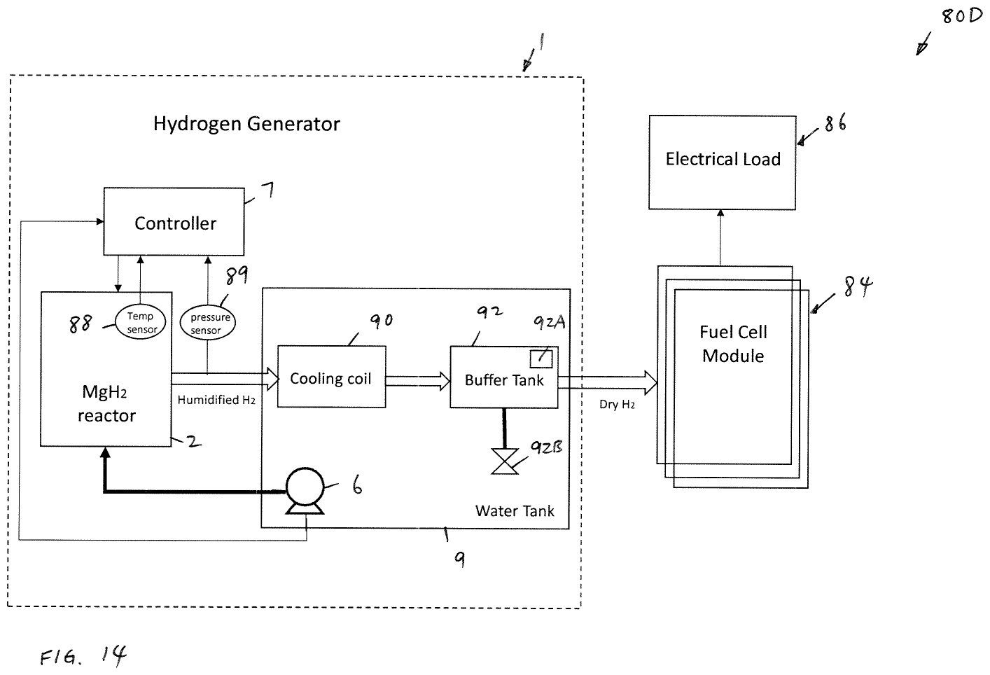

FIG. 14 illustrates a further variant of the energy power supply device of FIG. 10, which includes a cooling coil, a buffer tank, and a water pump, which are positioned inside a water tank,

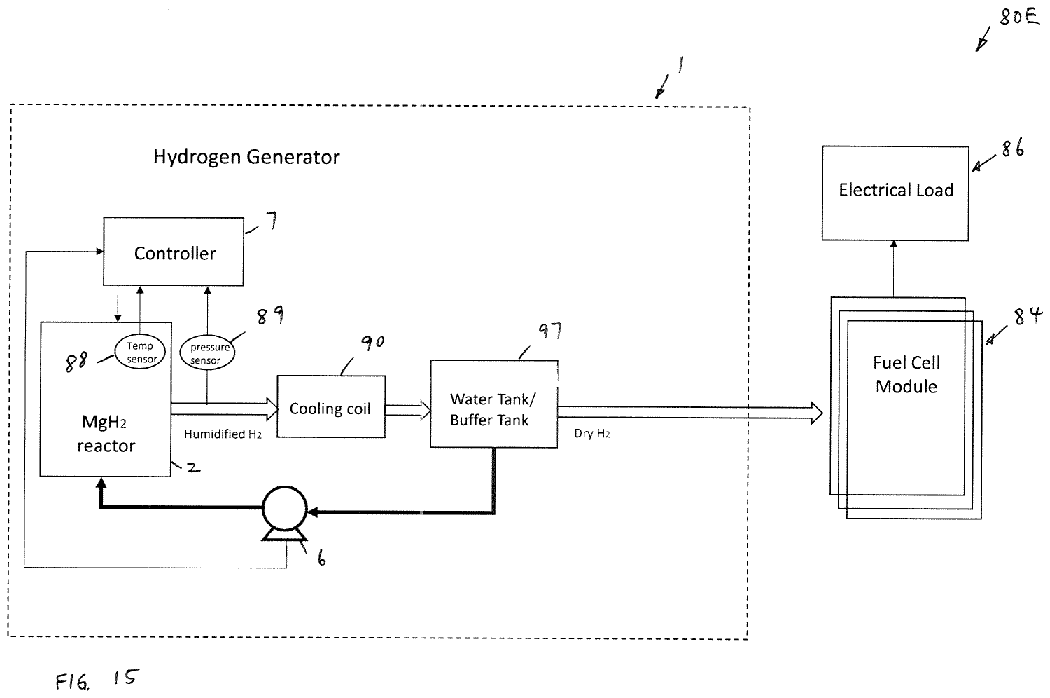

FIG. 15 illustrates another variant of the energy power supply device of FIG. 10, which includes water tank that serves as a supply water tank and a buffer tank,

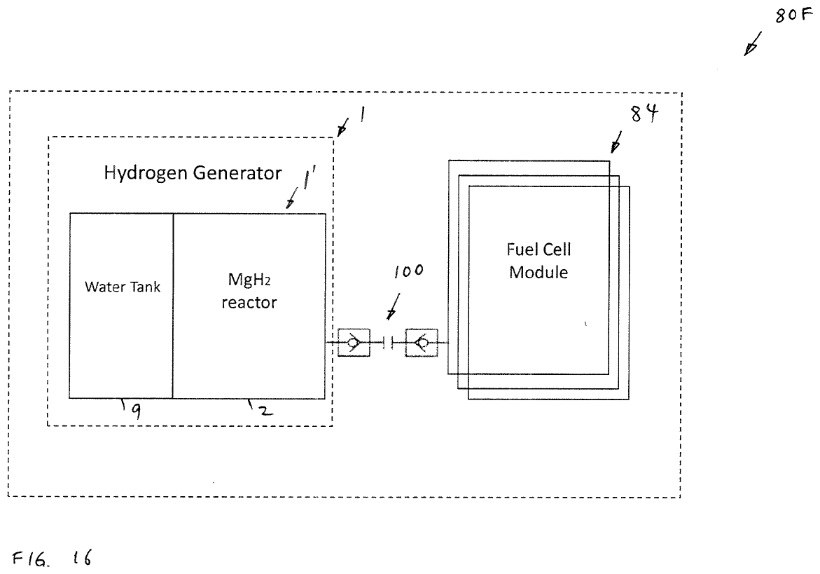

FIG. 16 illustrates a further variant of the energy power supply device of FIG. 10, which includes a connector for removable attachment between a fuel cell module and a hydrogen generator,

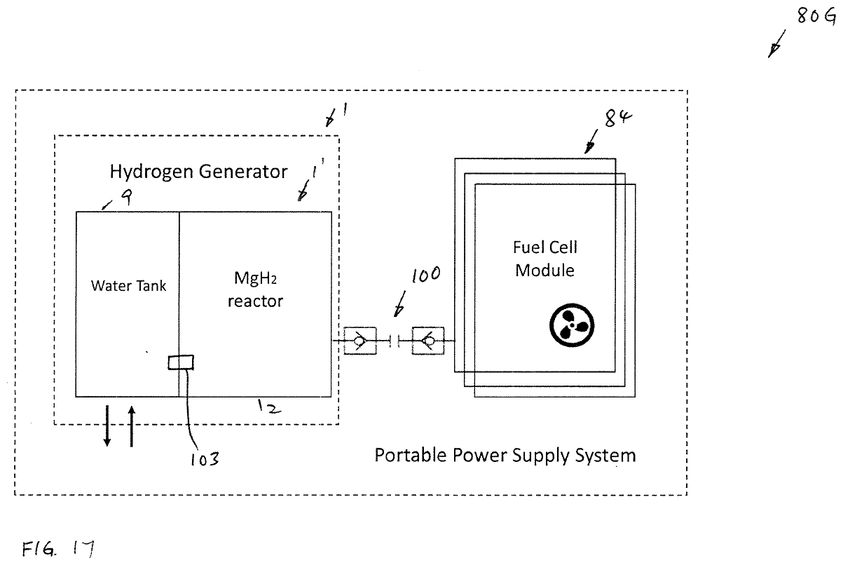

FIG. 17 illustrates a variant of the energy power supply device of FIG. 16, which includes a connector for removable attachment of a supply water tank to a hydrogen generator,

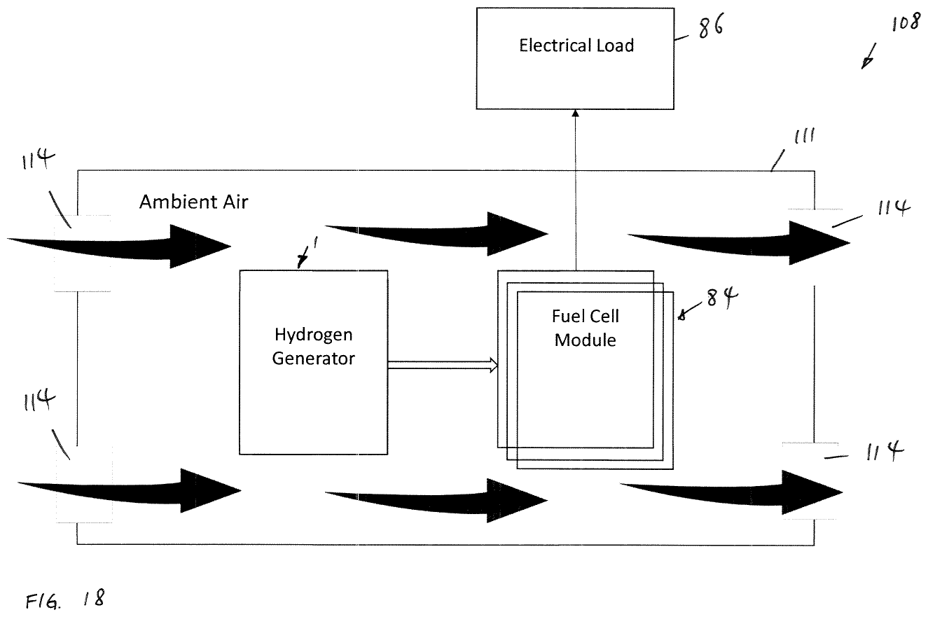

FIG. 18 illustrates a drone, which includes the energy power supply device of FIG. 10, which includes a fuel cell module and a hydrogen generator that are cooled by air that is drawn inside the drone when the drone is in flight,

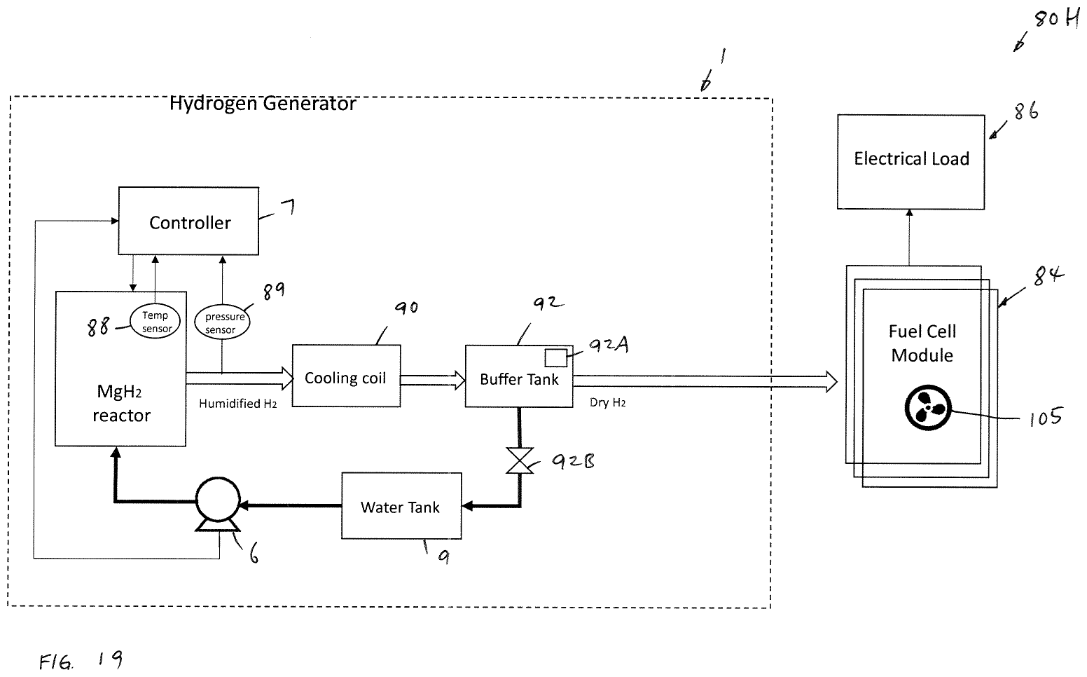

FIG. 19 illustrates a variant of the energy power supply device of FIG. 10, which includes a fan for cooling a fuel cell module,

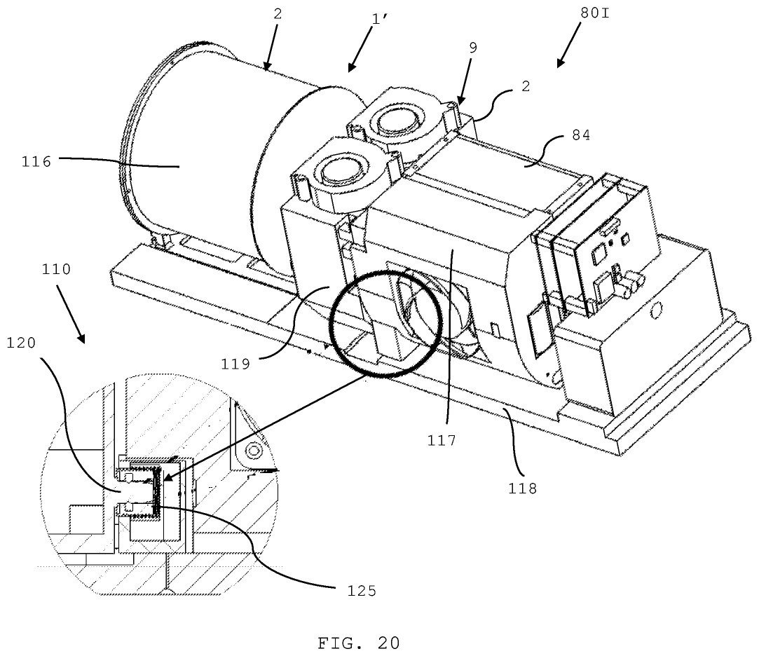

FIG. 20 illustrates a perspective view of a variant of the energy power supply device of FIG. 10, which includes a hydrogen generator and a fuel cell module that is attached to the hydrogen generator via a press-fit connector,

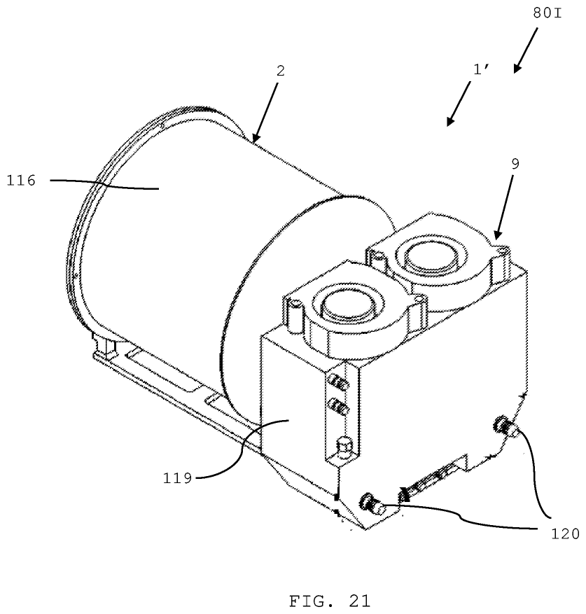

FIG. 21 illustrates a perspective view of the hydrogen generator of the energy power supply device of FIG. 20,

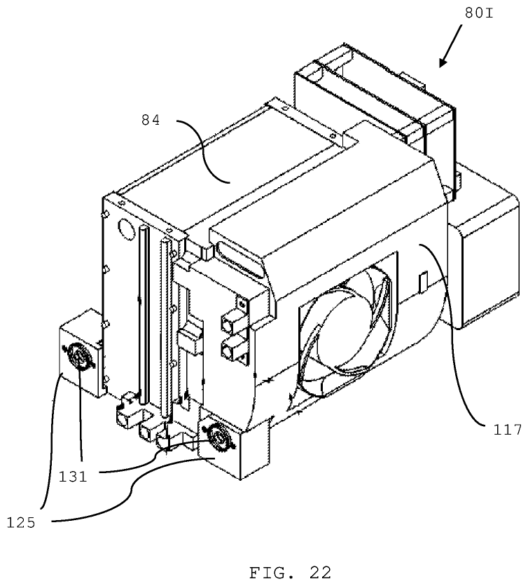

FIG. 22 illustrates a perspective view of the fuel cell module of the energy power supply device of FIG. 20, and

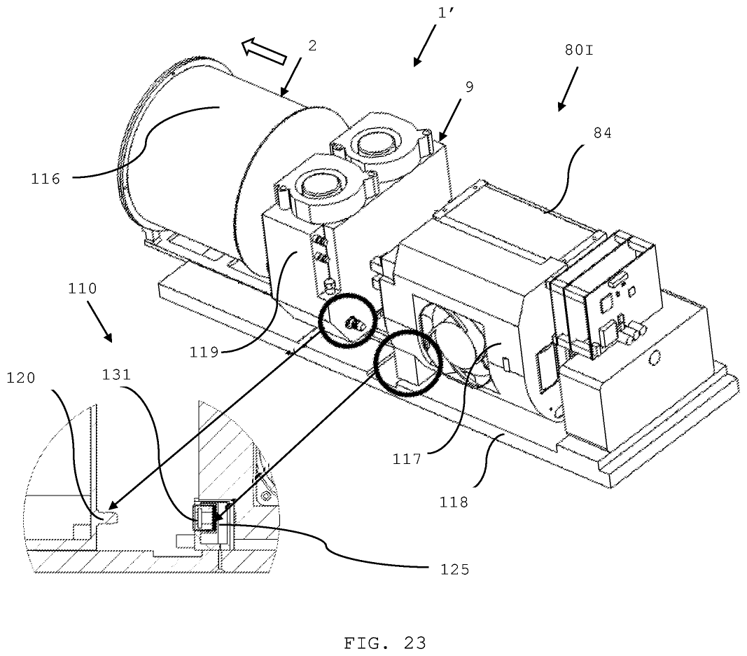

FIG. 23 illustrates a perspective view of the energy power supply device of FIG. 20, wherein the hydrogen generator and the fuel cell module are separated from each other.

The following detailed description is merely exemplary in nature and is not intended to limit the application and uses. Furthermore, there is no intention to be bound by any expressed or implied theory presented in the preceding technical field, background, brief summary or the following detailed description.

Some embodiments have similar parts. The similar parts may have the same names or similar part reference numerals with an alphabet or prime symbol. The description of one similar part also applies by reference to another similar part, where appropriate, thereby reducing repetition of text without limiting the disclosure.

FIG. 1 shows a simplified schematic view of a hydrogen generator according to one embodiment.

The hydrogen generator 1 comprises a reaction chamber 2, a water supply tubing 3, a water conduit tubing 4 for supplying water into the reaction chamber 2, a hydrogen collector 5 for collecting hydrogen generated in the hydrogen generation process, a water pump 6, a controller 7, a power supply 8, which is electrically connected to the water conduit tubing 4 to heat the water while it is being transported inside the water conducting tubing 4, and a water tank 9. The reaction chamber 2 is also called a reactor chamber.

A first end 50 of the water conduit tubing 4 is connected to the water supply tubing 3 inside the reaction chamber 2, and a second end 51 of the water conduit tubing 4 is connected to an outlet 24 of the pump 6 outside of the reaction chamber 2.

The reaction chamber 2 has an essentially axially symmetric shape with a vertical symmetry axis which is shown as a dash-dotted vertical line. The reaction chamber 2 has a side wall 10 with an upper face 48 and an outer surface 56, a bottom 11, and a cover 12. The reaction chamber 2 contains a filling 47 with a chemical reagent, such as a metal hydride, which is not visible in FIG. 1.

The bottom 11 of the reaction chamber 2 is made of an electrically conductive material and it has a first opening 31, a second opening 32 and a third opening 33. The first and second openings 31, 32 are arranged peripherally in the bottom 11 of the reaction chamber 2. The third opening 33 is arranged in a central region of the bottom 11 offset from the vertical symmetry axis of the reaction chamber 2. An insulator ring 36 is inserted in the third opening 33 of the bottom 11.

The water supply tubing 3 comprises a tubular body 13 with a first end 14 and a second end 15. The tubular body 13 has a porous wall 34 with a plurality of pores 37. The tubular body 13 is made of electrically conductive material.

The tubular body 13 of the water supply tubing 3 passes through the first opening 31 of the bottom 11 of the reaction chamber 2 and extends vertically upwards inside the reaction chamber 2 towards the cover 12 such that the first end 14 of the tubular body 13 is inside the reaction chamber 2 and the second end 15 of the tubular body 13 is outside the reaction chamber 2.

The water supply tubing 3 further comprises an electrically conducting top cap 16 that closes the first end 14 of the tubular body 13, and an electrically insulating bottom cap 17, that closes the second end 15 of the tubular body 13 of the water supply tubing 13.

The plurality of pores 37 in the wall 34 of the tubular body 13 of the water supply 3 tubing are provided in the region of the tubular body 13 which is inside the reaction chamber 2.

The water conduit tubing 4, which is partially depicted as a dash-dotted line for the sake of clarity, is made of electrically conductive material. The water conduit tubing 4 passes through the third opening 33 in the bottom 11 of the reaction chamber 2. The first end 50 and the plurality of windings 46 of the water conduit tubing 4 are inside the reaction chamber 2. The second end 51 of the water conduit tubing 4 is outside the reaction chamber 2. The water conduit tubing 4 has a helical part with a plurality of windings 46, which is inside the reaction chamber 2.

The first end 50 of the water conduit tubing 4, which is inside the reaction chamber 2, is connected to the top cap 16 of the water supply tubing 3. The second end 51 of the water conduit tubing 4, which is outside the reaction chamber 2, is connected to the outlet 24 of the pump 6 by means of a water supply pipe 40.

The hydrogen collector 5 comprises a tubular body 18 with a first end 19 and with a second end 20, and a top cap 21.

The tubular body 18 of the hydrogen collector 5 passes through the second opening 32 and extends vertically upwards inside the reaction chamber 2 towards the cover 12 such that the first end 19 is inside the reaction chamber 2 and the second end 20 is outside the reaction chamber 2. The top cap 21 closes the first end 19 of the tubular body 18. A hydrogen outlet pipe 22 is connected to and is closing the second end 20 of the tubular body 18 of the hydrogen collector 5.

The tubular body 18 of the hydrogen collector 5 has a porous wall 35 with a plurality of pores 38 which are provided in the region of the tubular body 18 that is inside the reaction chamber 2.

The pump 6 has a water inlet 23 and a water outlet 24. The water inlet 23 is connected to a water outlet 30 of the water tank 9 via a water tank pipe 39. The water outlet 24 of the pump 6 is connected to the second end 51 of the water conduit tubing 4, via the water supply pipe 40. The pump 6 is electrically connected with the controller 7 by means of a pump control line 42.

The power supply 8 has a first output contact 25 providing a positive terminal, a second output contact 26 providing a negative terminal and a control input 27. The first output contact 25 of the power supply 8 is connected to a contact 52 on the water conduit tubing 4 outside the reaction chamber 2 via first electric conduit 43. The second output contact 26 of the power supply 8 is connected to a contact 53 on the outer surface of the bottom 11 via a second electric conduit 44.

Thus, an electrical circuit is provided, in which electric current can flow from the first output contact 25 of the power supply 8, to the water conduit tubing 4, to the water supply tubing 3, to the second output contact 26 of the power supply 8. The control input 27 of the power supply 8 is connected to the controller 7.

The water tank 9 contains supply water 28 for supplying the hydrogen generator 1 with water. The water tank 9 has a water inlet 29 and a water outlet 30. The water outlet 30 of the water tank 9 is connected to the water pump 6 with the water tank pipe 39.

The cover 12 of the reaction chamber 2 comprises an essentially flat cover plate 54, with its inner surface 49 abutting against the upper face 48 of the side wall 10, and a peripheral cover ring 55 which encloses and presses against the outer surface 56 of the side wall 10 of the reaction chamber 2.

In a first start-up phase of a hydrogen generation process, if temperature reading is less than a start-up predefined threshold value, the controller 7 later activates the power supply 8 such that an electric current flow from the first output contact 25 of the power supply 8, to the water conduit tubing 4, to the water supply tubing 3, to the bottom 32 of the reaction chamber 2, and to the second output contact 26 of the power supply 8.

This flow of electric current then causes ohmic heating of the water conduit tubing 4, which leads to increase of water temperature inside the water conduit tubing 4 and also leads to increase of temperature inside the reaction chamber 2.

When the temperature of the reaction chamber 2 reaches a start-up predefined threshold value, the controller 7 activates the water pump 6 to transfer water from the water tank 9, to the water conduit tubing 4, to the water supply tubing 3, and to the reaction chamber 2.

The water then reacts with the chemical reagent to generate hydrogen gas.

In detail, the hydrogen is generated as a result of a chemical reaction taking place inside the reaction chamber 2 between the water, which is supplied from the water supply tubing 3, and the reagent, which is present in the filling 47 of the reaction chamber 2. The water for the reaction is pumped into the water supply tubing 4 from the water tank 9 by pumping the supply water 28 into the water conduit tubing 4 by means of the pump 6. The water gets into the reaction chamber 2 through the plurality of pores 37 in the wall 34 of the tubular body 13 of the water supply tubing 3. The distribution of the pores 37 over the length of the tubular body 13 of the water supply tubing 3 results in a spread of the water over the volume of the reaction chamber 2 where the water gets in contact and reacts with the reagent present in the filling 47 of the reaction chamber 2.

The reagent fills the inside of the reaction chamber. The reagent can be a metal compound, in particular a hydride. This hydrolysis reaction or interaction is an exothermic reaction during which heat inside the reaction chamber 2 is generated as well.

The following reaction, being provided as an example, takes place in which hydrogen is released

MH+yH₂O→(1−y)M₂O+(2y−1)MOH+H₂,

M symbolizing a 1-valent metal, y being in the interval of 0.51 to 0.9,

MH₂+yH₂O→(2−y)MO+(y−1)M(OH)₂+2H₂,

M symbolizing a divalent metal, y being in the interval of 1.02 to 1.8,

MH₃+yH₂O→(1⅓y)M₂O₃+(⅔y−1)M(OH)ₓ+3H₂,

M symbolizing a 3-valent metal, y being in the interval of 1.5 to 3, wherein the by-products of this equation are provided with general formulas and the equation is hence written in its unbalanced form for the purposes of simplicity,

MH₄+yH₂O→(2½y)MO₂+(½y−1)M(OH)₄+4H₂,

M symbolizing a 4-valent metal, y being in the interval of 2.04 to 3.6, wherein the by-products of this equation are provided with general formulas and the equation is thus written in its unbalanced form for the purposes of simplicity,

divalent metal M and particularly magnesium being preferred.

In the course of the hydrogen and heat generation, the pressure of the generated hydrogen gas within the volume of the reaction chamber 2 forces the hydrogen gas into the tubular body 18 of the hydrogen collector 5 through the pores 38 provided in the wall 35 of the tubular body 18. From the hydrogen collector 5, the hydrogen gas gets into the hydrogen output pipe 22. The hydrogen output pipe 22 is conducting the hydrogen gas to a hydrogen destination, which can be for example a hydrogen engine or a fuel cell.

The generated hydrogen gas often contains water vapour. This water vapour is later cooled by a cooling coil and is later stored in a buffer tank. The cooling coil and the buffer tank are described in detail below, in the figure description for FIG. 10.

This reaction is also exothermic in nature. Further heat is then generated inside the reaction chamber, which then causes a further elevation of the temperature inside the reaction chamber 2. The water conduit tubing 4 and the water inside the water conduit tubing 4 are heated as well.

When the temperature of the reaction chamber 2 reaches an operating predefined threshold value, the ohmic heating is no longer needed. The controller 7 then activates the power supply 8 such that the electric current stops flowing to the water conduit tubing 4 and the ohmic heating ceases.

The controller 7 also obtains pressure readings from a pressure sensor that can be located inside the reaction chamber 2 or be located at the hydrogen output pipe 22.

FIG. 2 shows a cross-sectional view of the tubular body 13 of the water supply tubing 3 of the hydrogen generator 1.

The tubular body 13 has a wall 34 with an outer surface 57 and with an inner surface 58. The wall 34 has an outer diameter D1 and a thickness h1. For the sake of simplicity, in this cross-sectional view only one pore 37 of the plurality of pores 37 is shown. The pore 37 has a diameter d1 and a length defined by the wall thickness h1. The small arrow in the figure shows the direction of the water flow during the operation of the hydrogen generator 1.

The wall 34 of the tubular body 13 is of metal or metal alloy.

In this embodiment, the pores are large enough to ensure sufficient water supply into the reactor and at the same time the pores are small enough in order to provide a well-defined water flow direction with a sufficient flow velocity to suppress hydrogen diffusion into the water supply tubing 3.

FIG. 3 shows a cross-sectional view of the tubular body 18 of the hydrogen collector 5 of the hydrogen generator 1.

The tubular body 18 has a wall 35 with an outer surface 59 and with an inner surface 60. The wall 35 has an outer diameter D2 and a thickness h2. For the sake of simplicity, in this cross-sectional view only one pore 38 of the plurality of pores 38 is shown. The pore 38 has a diameter d2 and a length defined by the wall thickness h2. The small arrow in the figure shows the direction of the hydrogen flow during the operation of the hydrogen generator 1.

The wall 35 of the tubular body 18 is made of metal or metal alloy.

In this embodiment, the pores 38 are large enough to ensure the flow of the hydrogen gas into the hydrogen collector 5 on the one hand and small enough to prevent the filling 47 of the reaction chamber 2 from entering into the hydrogen collector 5.

FIG. 4 shows a further hydrogen generator, which a variant of the hydrogen generator 1 of FIG. 1.

FIG. 4 shows a hydrogen generator 1A, which a variant of the hydrogen generator of FIG. 1. The hydrogen generator 1A and the hydrogen generator 1 include similar parts.

The hydrogen generator 1A includes a cylindrical reaction chamber 2, a supply water line, two elongated hydrogen collectors 5, and an external power supply 8. A part of the supply water line and the hydrogen collectors 5 are placed inside the reaction chamber 2. The supply water line includes a supply water tank 9, a coil of water conduit tubing 4 with an electrically conductive tubular body 13, and an elongated water dispenser 65.

The water conduit tubing 4 and the water dispenser 65 are placed inside the reaction chamber 2. The supply water tank 9 is fluidically connected to a first end of the water conduit tubing 4. A second end of the water conduit tubing 4 is fluidically connected to a water inlet of the water dispenser 65. These fluidic connections allow water to flow from the supply water tank 9, to the water conduit tubing 4, and to the water dispenser 65.

A positive electrical terminal of the external power supply 8 is electrically connected to the electrically conductive tubular body 13 of the electrically conductive water conduit tubing 4. A negative electrical terminal of the external power supply 8 is electrically connected to an outer electrically conductive surface of the reaction chamber 2. The electrically conductive tubular body 13 of the water conduit tubing 4 is electrically connected to the outer electrically conductive surface of the reaction chamber 2.

The water dispenser 65 includes a water cylinder with a porous wall 34 and an inner hollow part, which is surrounded by the porous wall 34. The wall 34 has a plurality of pores 37 to dispense water.

Similarly, each hydrogen collector 5 has a cylindrical form or body with a porous wall 35 and an inner hollow part, which is enclosed by the porous wall 35. The wall 35 has a plurality of gas pores 38.

The water dispenser 65, the water conduit tubing 4, the hydrogen collectors 5 are positioned essentially parallel to a longitudinal axis of the cylindrical reaction chamber 2.

The water dispenser 65 is placed in a central part of the reaction chamber 2, wherein a longitudinal axis of the water dispenser 65 is aligned essentially with a longitudinal axis of the cylindrical reaction chamber 2.

The coil of the water conduit tubing 4 surrounds the water dispenser 65, wherein a longitudinal axis of the water conduit tubing 4 is also aligned essentially with the longitudinal axis of the cylindrical reaction chamber 2.

The hydrogen collectors 5 are placed close to an inner surface of the cylindrical reaction chamber 2 and they are also placed symmetrically around the water dispenser 65. They are separated from the water conduit tubing 4 by a predetermined distance.

In use, the reaction chamber 2 is filled with a chemical reagent, namely metal hydride powder.

The external power supply 8 is later activated by a controller to provide an electrical current, which flows to the electrically conductive tubular body 13 of the water conduit tubing 4 and to the outer electrically conductive surface of the reaction chamber 2. The controller is not shown in FIG. 4. The electrical current causes a temperature of the water conduit tubing 4 to increase.

The heated water conduit tubing 4 subsequently causes a temperature of the water in the heated water conduit tubing 4 and temperature of metal hydride powder in the reaction chamber 2 to increase while the water is being transported inside the water conduit tubing 4.

The heated water is later transferred by the water pump to the inner hollow part of the elongated water dispenser 65.

The heated water then flows from the water dispenser 65 to an inner part of the reaction chamber 2. In particular, the heated water flows from the inner hollow part of the water dispenser 65, to the water pores 37 of the porous wall 34 of the water cylinder of the water dispenser 65, and to an external part of the water dispenser 65, which is placed inside of the reaction chamber 2.

The heated water subsequently interacts with the heated metal hydride powder inside the reaction chamber 2 to generate hydrogen gas. The heat in the water as well as the heated chemical reagent act to trigger and to accelerate this interaction.

The generated hydrogen gas is afterward received by the hydrogen collectors 5.

The gas pores 38, while permitting the hydrogen gas to flow through the pores 38, is small enough to prevent the metal hydride powder that are provided in the inside of the reaction chamber 2 to enter these pores 38.

This above described interaction between the water and the metal powder also generates additional heat. In other words, this interaction is exothermic.

The additional heat is later received by the coil of the water conduit tubing 4, which is positioned to surround the water dispenser 65, is able to receive and capture the generated additional heat. This then acts to increase further the temperature of the water conduit tubing 4. The additional heat can convert the water in the water conduit tubing 4 to a gaseous state. In other words, this liquid water is turned to steam.

When the temperature of the reaction chamber 2 or chemical reagent reaches a predetermined interaction temperature limit, the controller instructs the external power supply 8 to stop providing electrical current to the water conduit tubing 4. The heat from the interaction between the water and the metal hydride powder is then sufficient to heat the water in water conduit tubing 4 for triggering further said interaction.

The hydrogen generator 1A provides a benefit in that the coil of the water conduit tubing 4 surrounds the water dispenser 65 for effectively receiving heat from the interaction between water from the water dispenser 65 and the metal hydride powder in the reaction chamber 2. The heat thereby allows further said interactions. In other words, the process is self-sustaining.

FIG. 5 shows another hydrogen generator, which includes a heater for a water dispenser.

FIG. 5 depicts a hydrogen generator 1B, which is a variant of the hydrogen generator 1A. The hydrogen generator 1B and the hydrogen generator 1A include similar parts.

In detail, the hydrogen generator 1A includes a water dispenser heater 68, which is placed in a water dispenser 65 of the hydrogen generator 1B.

An external power supply 8 is electrically connected to the water dispenser heater 68.

In use, the reaction chamber 2 is filled with metal hydride powder.

The external power supply 8 is later activated by a controller to provide an electrical current, which flows through the water dispenser heater 68. The electrical current causes a temperature of the water dispenser 65 to increase.

The heated water dispenser 65 subsequently causes a temperature of the water in the heated water dispenser 65 to increase.

The heated water then flows from the water dispenser 65 to the inside of the reaction chamber 2.

The heated water later interacts with the metal hydride powder inside the reaction chamber 2 to generate hydrogen gas.

The generated hydrogen gas is afterward received by the hydrogen collectors 5.

The water dispenser heater 68 provides a means to increase effectively the temperature of the water in the water dispenser heater 68.

FIG. 6 shows another hydrogen generator, which includes two flat hydrogen collectors being arranged perpendicular to a water dispenser.

FIG. 6 depicts a hydrogen generator 1C, which is a variant of the hydrogen generator 1A. The hydrogen generator 1C and the hydrogen generator 1A include similar parts.

The hydrogen generator 1C includes one cylindrical reaction chamber 2 and two hydrogen collectors 5.

The reaction chamber 2 includes a cylindrical body 2-1 with a flat plate 2-2. The flat plate 2-2 is attached to one end of the cylindrical body 2-1. The two hydrogen collectors 5 are attached to the flat plate 2-2.

The water dispenser 65 and the coil of the water conduit tubing 4 are positioned essentially parallel to the cylindrical reaction chamber 2.

The water dispenser 65 is placed in a central part of the reaction chamber 2, wherein a longitudinal axis of the water dispenser 65 is aligned essentially with a longitudinal axis of the cylindrical reaction chamber 2.

The coil of the water conduit tubing 4 surrounds the water dispenser 65, wherein a longitudinal axis of the coil of the water conduit tubing 4 is also aligned essentially with the longitudinal axis of the cylindrical reaction chamber 2.

The hydrogen collectors 5 are positioned essentially perpendicular to the longitudinal axis of the cylindrical reaction chamber 2.

In one implementation, walls of the reaction chamber 2 includes a thermal insulating material. The insulation material acts to retain heat within the reaction chamber 2.

In one implementation, walls of the reaction chamber 2 includes a thermal conductive material. The thermal conductive material acts to dissipate retain heat within the reaction chamber 2.

A user can select the above-mentioned type of material, either the thermal insulating material or the thermal conductive material, according to design of the reaction chamber.

FIG. 7 shows a further hydrogen generator, which includes one water dispenser with several hydrogen collectors.

FIG. 7 depicts a hydrogen generator 1D, which is a variant of the hydrogen generator 1A. The hydrogen generator 1D and the hydrogen generator 1A include similar parts.

The hydrogen generator 1D includes a cylindrical reaction chamber 2, a supply water line, and five elongated hydrogen collectors 5. The supply water line includes a coil of water conduit tubing 4 and an elongated water dispenser 65.

The water dispenser 65, the water conduit tubing 4, the hydrogen collectors 5 are positioned essentially parallel to an axis of the cylindrical reaction chamber 2.

The water dispenser 65 is placed in a central part of the reaction chamber 2 while the coil of the water conduit tubing 4 surrounds the water dispenser 65.

The hydrogen collectors 5 are placed close to an inner surface of the cylindrical reaction chamber 2 and they are also placed symmetrically around the water dispenser 65. They are separated from the water conduit tubing 4 by a predetermined distance.

This arrangement provides a device for collecting hydrogen gas, wherein several hydrogen collectors are evenly distributed about one water dispenser 65 for effective collection of the generated hydrogen gas.

FIG. 8 shows illustrates a further hydrogen generator, which includes several water dispensers with several corresponding hydrogen collectors.

FIG. 8 depicts a hydrogen generator 1E, which is a variant of the hydrogen generator 1A. The hydrogen generator 1E and the hydrogen generator 1A include similar parts.

The hydrogen generator 1E includes a reaction chamber 2, and a supply water line with five elongated hydrogen collectors 5.

The supply water line includes four coils of water conduit tubing 4 with four corresponding elongated water dispensers 65.

The water dispensers 65, the coils of the water conduit tubing 4, the hydrogen collectors 5 are positioned essentially parallel to an axis of the cylindrical reaction chamber 2.

The water dispensers 65 are placed symmetrically around a central part of the reaction chamber 2. In other words, the water dispensers 65 are separated from the central part of the reaction chamber 2 by a first predetermined distance while each water dispenser 65 is separated from adjacent water dispenser 65 by a second predetermined distance.

The coil of the water conduit tubing 4 surrounds the respective water dispenser 65, wherein a longitudinal axis of the coil of the water conduit tubing 4 is aligned essentially with a longitudinal axis of the respective water dispenser 65.

One hydrogen collector 5 is placed at the central part of the reaction chamber 2. The remaining four hydrogen collectors 5 are placed symmetrically around the central part of the reaction chamber 2. Each of the remaining four hydrogen collectors 5 is separated from the adjacent hydrogen collector 5 by a predetermined distance.

These four or multiple water dispensers provide several benefits.

For producing the same amount of hydrogen gas, as compared to an arrangement with just one water dispenser, these four water dispensers can be shorter.

Furthermore, the shorter water dispenser allows the water dispenser to provide a more even rate of water discharge. Rate of water discharge at an end part of the water dispenser that is close to the supply water inlet has a similar rate of water discharge at another end part of the water dispenser that is further away from the supply water inlet. The even or similar rate of water discharge enables a more predictable hydrogen generation process.

During operation of the hydrogen generator, the reaction chamber as well as these water dispensers are subjected to heat. The shorter water dispenser allows for a more even water distribution within the water dispenser, thereby allowing for a more even heat distribution across the water dispenser. Temperature of one end of the water dispenser is close to temperature of the other end of the water dispenser. This then allows the water dispenser to be subjected to less thermal stress and enables the water dispenser to last longer.

FIG. 9 shows a further hydrogen generator, which includes a reaction chamber with a doughnut-shaped housing.

FIG. 9 shows a hydrogen generator 1F, which is a variant of the hydrogen generator 1E. The hydrogen generator 1F and the hydrogen generator 1E include similar parts.

The hydrogen generator 1F includes a reaction chamber 2F with a fan 70 and a supply water line with four elongated hydrogen collectors 5. The supply water line includes four coils of water conduit tubing 4 with four corresponding elongated water dispensers 65.

The reaction chamber 2F has a housing that has a doughnut shape. The doughnut shape refers to a shape of a ring with a hollow centre. The fan 70 is attached to a central hollow region of the housing.

The water dispensers 65, the water conduit tubing 4, the hydrogen collectors 5 are positioned essentially parallel to the cylindrical reaction chamber 2. The water dispensers 65 are placed symmetrically around a central part of the reaction chamber 2.

The coil of the water conduit tubing 4 surrounds the respective water dispenser 65 while the four hydrogen collectors 5 are placed symmetrically around the central part of the reaction chamber 2.

The doughnut shaped housing provides a benefit in that it allows an inner part of the reaction chamber 2F to be cooled by the fan 70. This is especially important, when the reaction chamber 2F is very hot.

FIG. 10 shows an energy power supply device that includes a hydrogen generator of FIG. 1 or 4.

FIG. 10 depicts an energy power supply device 80 that includes a hydrogen generator 1 and a fuel cell module 84 for providing electrical power to an electrical load 86.

A gas outlet of the hydrogen generator 1 is fluidically connected to a gas inlet of the fuel cell module 84. An electrical power outlet of the fuel cell module 84 is electrically connected to an electrical power inlet of an electrical load 86.

In detail, the hydrogen generator 1 includes a reaction chamber 2, a water pump 6, a supply water tank 9, a cooling coil 90, a buffer tank 92, and a controller 7. The buffer tank 92 includes a water level sensor 92A and an electric water outlet valve 92B.

A water outlet of the supply water tank 9 is fluidically connected to a water inlet of the reaction chamber 2. A hydrogen gas outlet of the reaction chamber 2 is fluidically connected to a hydrogen gas inlet of the cooling coil 90. A hydrogen gas outlet of the cooling coil 90 is fluidically connected to a gas inlet of the buffer tank 92.

A water outlet of the buffer tank 92 is fluidically connected to a water inlet of the water tank 9. A hydrogen gas outlet of the buffer tank 92 is fluidically connected to a gas inlet of the fuel cell module 84. An electrical power outlet of the fuel cell module 84 is electrically connected to the electrical load 86.

The controller 7 is electrically connected to the water pump 6, to a temperature sensor 88 that is placed inside the reaction chamber 2, and to a pressure sensor 89 that is placed inside the reaction chamber 2 or placed close to the hydrogen gas outlet of the reaction chamber 2.

The controller 7 is also electrically connected to the buffer tank water level sensor 92A and the buffer tank water outlet valve 92B.

In use, the controller 7 acts to receives readings of the temperature sensor 88 and readings of the pressure sensor 89.

The controller 7 then activates the water pump 6 according to the readings of the temperature sensor 88. The controller 7 then regulates or adjusts the pump rate of the water pump 6 according to the readings of the pressure sensor 89.

The activated water pump 6 acts to transfer water from the supply water tank 9 to the reaction chamber 2.

The cooling coil 90 acts to receive the hydrogen gas from the reaction chamber 2 and also acts to cool this hydrogen gas. The hydrogen gas from the reaction chamber 2 often contains water vapour. The cooling coil 90 then reduces temperature of the hydrogen gas and temperature of the water vapour. The water vapour is often converted to water that is the liquid state.

The buffer tank 92 acts to receive the hydrogen gas and the water from the cooling coil 90. The buffer tank 92 acts to separate the hydrogen gas from the water, wherein the hydrogen gas is intended for flowing to the fuel cell module 84 and the water is intended for flowing to the water tank 9.

In one implementation, the gas outlet of the buffer tank 92 is placed at an upper part of the buffer tank 92 while the water outlet of the buffer tank 92 is placed at lower part of the buffer tank 92.

The gas inlet is used for receiving hydrogen gas and water from the cooling coil 90. The water then flows downwards and flows out of the buffer tank 92 via the lower water outlet. The hydrogen gas rises upwards and flows out of the buffer tank 92 via the upper gas outlet.

The fuel cell module 84 afterward converts the hydrogen gas from the buffer tank 92 to electrical power, which is then transmitted to the electrical load 86.

The controller 7 also receives readings of the water level sensor 92A of the buffer tank 92 and it actuates the water outlet valve 92B of the buffer tank 92 according to these readings of the water level sensor 92A. When the controller 7 actuates the water outlet valve 92B to an open position, water from the buffer tank 92 can flow to the water tank 9. When the controller 7 actuates the water outlet valve 92B to a closed position, water from the buffer tank 92 cannot flow to the water tank 9.

FIG. 11 shows a variant of the energy power supply device of FIG. 10, which includes an impurity filter.

FIG. 11 shows an energy power supply device 80A. The energy power supply device 80A and the energy power supply device 80 have similar parts.

The energy power supply device 80A includes an impurity filter 94. A gas inlet of the impurity filter 94 is fluidically connected to a gas outlet of the buffer tank 92 and a gas outlet of the impurity filter 94 is fluidically connected to a gas inlet of the fuel cell module 84.

In use, the impurity filter 94 is intended to receive hydrogen gas from the buffer tank 92. The impurity filter 94 acts to remove impurities or foreign particles from this hydrogen gas. The purified hydrogen gas then flows from the impurity filter 94 to the fuel cell module 84.

The impurity filter 94 provides a benefit in that it removes impurities from the hydrogen gas that is intended for use by the fuel cell module 84. This can be important especially when the hydrogen gas from the reaction chamber 2 contains impurities that can affect operation of the fuel cell module 84.

In a general sense, the impurity filter 94 can also be connected directly to a gas outlet of the reaction chamber 2 or to a gas outlet of to the cooling coil 90.

FIG. 12 shows a further variant of the energy power supply device of FIG. 10, which includes a fan for cooling a cooling coil.

FIG. 12 shows an energy power supply device 80B. The energy power supply device 80B and the energy power supply device 80 have similar parts.

The energy power supply device 80B includes a fan 90B that is placed near to a cooling coil 90.

In use, the fan 90B acts to reduce temperature of the cooling coil 90.

The fan 90B provides a benefit in that it acts to improve heat reduction efficiency of the cooling coil 90.

The cooling coil 90 is intended for removing heat from hydrogen gas that flows through the cooling unit 90. Reducing the temperature of the cooling coil 90 then also improves its ability to reduce temperature of hydrogen gas that flows through the cooling unit 90.

FIG. 13 shows another variant of the energy power supply deice of FIG. 10, which includes a cooling coil that is positioned inside a water tank.

FIG. 13 shows an energy power supply device 80C. The energy power supply device 80C and the energy power supply device 80 have similar parts.

The energy power supply device 80C includes a cooling coil 90 and a supply water tank 9, wherein the cooling coil 90 is positioned inside the supply water tank 9.

In use, water in the supply water tank 9 acts to remove heat from the cooling coil 90.

This is useful, since the cooling coil 90 is intended for removing heat from hydrogen gas that flows through the cooling unit 90.

FIG. 14 shows a further variant of the energy power supply device of FIG. 10, which includes a cooling coil, a buffer tank, and a water pump, which are positioned inside a water tank.

FIG. 14 shows an energy power supply device 80D, wherein the energy power supply device 80D and the energy power supply device 80 have similar parts.

The energy power supply device 80D includes a cooling coil 90, a buffer tank 92, a water pump 6, and a supply water tank 9. The cooling coil 90, the buffer tank 92, and the water pump 6 are positioned inside the supply water tank 9.

This arrangement allows the water tank 9 to use spaces among the cooling coil 90, the buffer tank 92, and the water pump 6 to store water that is intended for flowing to the reaction chamber 2.

The energy power supply device 80D provides a benefit in that it takes up a smaller space. This is useful, especially in applications that the energy power supply device to be small.

FIG. 15 shows variant of the energy power supply device of FIG. 10, which includes water tank that serves as a supply water tank and a buffer tank.

FIG. 15 shows an energy power supply device 80E. The energy power supply device 80E and the energy power supply device 80 have similar parts.

The energy power supply device 80E includes an integrated buffer tank 97. A gas inlet of the tank 97 is fluidically connected to a gas outlet of a cooling coil 90. A gas outlet of the tank 97 is fluidically connected to a gas inlet of a fuel cell module 84. A water outlet of the tank 97 is fluidically connected to a water inlet of a water pump 6.

In application, the tank 97 is used to receive hydrogen gas with water from the cooling coil 90.

The tank 97 acts a buffer tank in that it acts to separate the hydrogen gas from the water and then allows the hydrogen gas to flow to the fuel cell module 84.

The tank 97 also acts a supply water tank in that it later supplies the water to a reaction chamber 2. In detail, the water in the tank 97 flows to a water pump 6, which later transfers the water to the reaction chamber 2.

This arrangement provides a benefit in that it provides one tank for acting as two parts, namely a supply water tank and a buffer tank, thereby acting to reduce number of parts needed for building the energy power supply device 80E.

FIG. 16 shows a variant of the energy power supply device of FIG. 10, which includes a connector for removable attachment between a fuel cell module and a hydrogen generator.

FIG. 16 shows an energy power supply device 80F. The energy power supply device 80F and the energy power supply device 80 have similar parts.

The energy power supply device 80F includes a cartridge module 1′, a fuel cell module 84, and a connector 100. The cartridge module 1′ is removably connected to the fuel cell module 84 via the connector 100. The cartridge module 1′ comprises a reaction chamber 2 and a supply water tank 9.

In use, the reaction chamber 2 is used for containing a chemical reagent. The water tank 9 is used to supply water to the reaction chamber 2, wherein the water interacts with the reagent to generate hydrogen gas.

After a predetermined period of operation, the water in the water tank 9 is spent. The connector 100 then allows the cartridge module 1′ to be removed, wherein a new cartridge module 1′ can be connected to the connector 100.

The connector 100 allows a user to change easily the cartridge module in a few steps. This is particular useful, when the user is in the field.

FIG. 17 shows a variant of the energy power supply device of FIG. 16, which includes a connector for removable attachment of a supply water tank to a hydrogen generator.

FIG. 17 shows an energy power supply device 80G. The energy power supply device 80G and the energy power supply device 80F have similar parts.

The energy power supply device 80G includes a connector 103 that removable connects a supply water tank 9 to a reaction chamber 2.

This connector 103 enables a user to replace the water tank 9 easily. This is particularly useful, especially when the user or operator is in the field.

FIG. 18 shows an improved drone as one of the applications that can benefit from the disclosed energy power supply device, though this disclosure by no means is not limited to drones only. The drone refers to an unmanned aircraft vehicle.

FIG. 18 depicts a drone 108, which includes a housing 111, a hydrogen generator 1 and a fuel cell module 84.

The housing 111 with openings 114 and it encloses the hydrogen generator 1 and the fuel cell module 84.

In use, the housing 111 protects the hydrogen generator 1 and the fuel cell module 84 from the surrounding. When the drone 108 is in flight, the opening 114 allows surrounding air to enter the housing 111 to cool the hydrogen generator 1 and the fuel cell module 84.

FIG. 19 shows a variant of the energy power supply device of FIG. 10, which includes a fan for cooling a fuel cell module.

FIG. 19 shows an energy power supply device 80H. The energy power supply device 80H and the energy power supply device 80 have similar parts.

The energy power supply device 80H includes a fan 105 that is positioned near to a fuel cell module 84.

In use, the fan 105 is used for reducing temperature of the fuel cell module 84.

FIG. 20 shows a further variant of the energy power supply device of FIG. 10, which includes a connector for removable attachment between a hydrogen generator and a fuel cell module.

FIG. 20 shows an energy power supply device 80I. The energy power supply device 80I and the energy power supply device 80 have similar parts.

The energy power supply device 80I includes a base plate 118, a cartridge module 1′, and a fuel cell module 84. The cartridge module 1′ and the fuel cell module 84 are slidably connected to the base plate 118. The cartridge module 1′ is removably connected to the fuel cell module 84.

As better seen in FIG. 21, the cartridge module 1′ includes a reaction chamber 2 with a cylindrical reaction chamber housing 116, and a supply water tank 9 with a water tank housing 119 that has a substantially cuboid-shape. The reaction chamber 2 is placed inside the reaction chamber housing 116, which is connected to the supply water tank 9. The supply tank 9 includes two cartridge plungers 120, which are attached to an outer surface of the water tank housing 119 at first predetermined positions. Each of the cartridge plungers 120 is provided in a form of a pin having a predetermined pin diameter.

As better seen in FIG. 22, the fuel cell module 84 includes a substantially cuboid-shaped fuel cell module casing 117. The fuel cell module casing 117 includes two cartridge housings 125, which are attached to an outer surface of the fuel cell module casing 117 at second predetermined positions. The second predetermined positions correspond to the first predetermined positions. Each of the cartridge housings 125 includes a hole 131 with a predetermined hole diameter. The hole 131 is adapted to receive the corresponding pin of the cartridge plungers 120 and to secure the corresponding cartridge plungers 120 by press-fit. Put differently, the pins of the cartridge plungers 120 are inserted into the corresponding holes 131 of the cartridge housings 125 with a small force. The holes 131 then grip the pins, thereby fixing the cartridge module 1′ to the fuel cell module 84.

The cartridge module 1′ can also be separated from the fuel cell module 84 by pulling the cartridge module 1′ and the fuel cell module 84 away from each other with a small force, as shown in FIG. 23.

In one embodiment, the cartridge plungers 120 are attached to an outer surface of the fuel cell module casing 117 of the fuel cell module 84 while the cartridge housings 125 are attached to an outer surface of the water tank housing 119 of the cartridge module 1′.

The cartridge housings 125 and the corresponding cartridge plungers 120 together act to provide a press-fit connector.

This press-fit connector enables a user to replace the cartridge module 1′ easily when water in the water tank 9 is depleted, wherein a new cartridge module 1′ can be connected to the fuel cell module 84. This is useful, especially when the user is in the field.

In another special embodiment, the cartridge plungers 120 are removably attached to the fuel cell module 84 while the cartridge housings 125 are also removably attached to the cartridge module 1′. This feature of removable attachment allows a user to replace a damaged or worn cartridge plunger 120 with a new cartridge plunger 120 or to replace a damaged or worn cartridge housing 125 with a new cartridge housing 125 easily and quickly. This will result in reduction of the maintenance cost of the energy power supply device 80I.

In a special embodiment, each of the cartridge plungers 120 further includes a fluidic channel, which is located inside the cartridge plunger 120. The cartridge plunger 120 is removably connected to a hydrogen gas outlet of the cartridge module 1′ and to a gas inlet of the fuel cell module 84. The fluidic channel acts to allow generated hydrogen gas to be transmitted from the cartridge module 1′ to the fuel cell module 84.

Examples for different aspects of the application are listed below.

1. A hydrogen generator comprising
a water supply tubing (3) for supplying water into a reaction chamber (2) which is adapted for housing a process for generating hydrogen,
a hydrogen collector (5) for collecting hydrogen generated in the hydrogen generation process,
a water conduit tubing (4) having a first end (50), a second end (51) and an electrically conductive body with a plurality of windings (46), wherein the water supply tubing (3), the hydrogen collector (5), and the water conduit tubing (4) are at least partially inside the reaction chamber (2),
a water pump (6), wherein the first end (50) of the water conduit tubing (4) is connected to the water supply tubing (3) and the second end (51) of the water conduit tubing (4) is connected to an outlet (24) of the pump (6),
a power supply (8), the power supply (8) is electrically connected to the water conduit tubing (4), and
a controller (7), the controller (7) is adapted to
   activate the pump (6) for transferring water to the water supply tubing (3) through the water conduit tubing (4),
   activate the power supply (8) in such way that an electric current flow through the electrically conductive body of the water conduit tubing (4) in order to increase a temperature of water conduit tubing (4) and temperature of the water while the water is being transported through the water conduit tubing (4) for controlling the process of hydrogen generation.

Example 2. The hydrogen generator according to example 1, wherein

the reaction chamber (2) comprises a side wall (10), a bottom (11), and a cover (12), and wherein a first opening (31) for mounting the water supply tubing (4), a second opening (32) for mounting the hydrogen collector (5), and a third opening (33) for mounting of the water conduit tubing (4) are provided in the bottom (11) of the reaction chamber (2).

Example 3. The hydrogen generator according to example 2, wherein

the water supply tubing (3) comprises a tubular body (13) having a first end (14), a second end (15) and a porous wall (34) with a plurality of pores (37), and wherein the tubular body (13) of the water supply tubing (3) passes through the first opening (31) of the reaction chamber (2) and extends vertically upwards inside the reaction chamber (2) towards the cover (12) such that the first end (14) of the tubular body (13) is inside the reaction chamber (2) and the second end (15) of the tubular body (13) is outside the reaction chamber (2), and wherein

the first end (50) of the water conduit tubing (4) is connected to the water supply tubing (4) at the first end (14) of the tubular body (13) inside the reaction chamber (2).

Example 4. The hydrogen generator according to example 2 or example 3, wherein

the hydrogen collector (5) comprises a tubular body (18) having a first end (19), a second end (20) and a porous wall (35) with a plurality of pores (38), and wherein the tubular body (18) of the hydrogen collector (5) passes through the second opening (32) of the reaction chamber (2) and extends vertically upwards inside the reaction chamber (2) towards the cover (12) such that the first end (19) of the tubular body (18) of the hydrogen collector (5) is inside the reaction chamber (2) and the second end (20) of the tubular body (18) of the hydrogen collector (5) is outside the reaction chamber (2).

Example 5. The hydrogen generator according to one of the examples 2 to 4, wherein

the water conduit tubing (4) passes through the third opening (33) of the reaction chamber (2) such that the plurality of windings (46) of the water conduit tubing (4) is inside the reaction chamber (2) and the second end (51) of the water conduit tubing (4) is outside the reaction chamber (2).

Example 6. The hydrogen generator according to one of the examples 3 to 5, wherein the plurality of pores (37) in the wall (34) of the tubular body (13) of the water supply tubing (3) is provided in the region of the tubular body (13) which is inside the reaction chamber (2).

Example 7. The hydrogen generator according to one of the examples 4 to 6, wherein

the plurality of pores (38) in the wall (35) of the tubular body (18) of the hydrogen collector (5) is provided in the region of the tubular body (18) which is inside the reaction chamber (2).

Example 8. The hydrogen generator according to one of the examples 5 to 7, wherein

the bottom (11) of the reaction chamber (2) is electrically conductive, and wherein

the water supply tubing (3) further comprises an electrically conductive top cap (16) closing the first end (14) of the tubular body (13) of the water supply tubing (3), the top cap being connected to the first end (50) of the water conduit tubing (4), and an electrically insulating bottom cap (17), closing the second end (15) of the tubular body (13) of the water supply tubing (3), wherein

the tubular body (13) of the water supply tubing (3) is electrically conductive and electrically connected with the bottom (11) of the reaction chamber (2), and wherein the third opening (33) contains an insulator ring (36), electrically isolating the water conduit tubing (4) from the bottom (11).

Example 9. The hydrogen generator according to example 8, wherein

the power supply (8) has a first output contact (25) providing a positive terminal, a second output contact (26) providing a negative terminal and a control input (27), wherein the first output contact (25) is connected to a contact (52) on the water conduit tubing (4) outside the reaction chamber (2) and the second output contact (26) is connected to a contact (53) on the outer surface of the bottom (11).

Example 10. The hydrogen generator according to one of the examples 4 to 9, wherein

the hydrogen collector (5) further comprises a top cap (21) closing the first end (19) of the tubular body (18), and wherein

a hydrogen outlet pipe (22) is connected with and is closing the second end (20) of the tubular body (18).

Example 11. The hydrogen generator according to one of the previous examples, wherein

a water tank (9) is provided, and wherein a water inlet (23) of the pump (6) is connected to a water outlet (30) of a water tank (9) with a water tank pipe (39).

Example 12. The hydrogen generator according to one of the example 3 to 11, wherein

the tubular body (13) of the water supply tubing (3) is made of an electrically conductive material such as stainless steel or any other electrically conductive material that is chemically compatible with the contents of the hydrogen generator.

Example 13. A hydrogen generator comprising
a water dispenser (3) for providing water in a reaction chamber (2),
a hydrogen collector (5) for collecting hydrogen generated inside the reaction chamber (2),
a water conduit tubing (4), the water conduit tubing (4) comprising at least an electrically conductive portion and being connected to the water dispenser (3),
a water pump (6) for pumping water through the water conduit tubing (4) into the water dispenser (3),
a power supply (8) for providing an electric current in an electric path comprising the electrically conductive portion of the water conduit tubing (4), and
a controller (7) controlling the electric current and the water pumping rate.

Example 14. The hydrogen generator according to example 13, wherein

at least one portion of the reaction chamber (2) is electrically conductive, and wherein the electric path comprises the at least one electrically conductive portion of the reaction chamber (2).

Example 15. The hydrogen generator according to example 13 or 14, wherein

the water conduit tubing (4) has essentially helical shape and has a plurality of windings (46) inside the reaction chamber (2).

Example 16. The hydrogen generator according to one of the examples 13 to 15, wherein

the water dispenser (3) comprises a porous wall (34) with a plurality of pores (37) and the hydrogen collector (5) comprises a porous wall (35) with a plurality of pores (38).

Example 17. The hydrogen generator according to one of the examples 13 to 16, wherein

a water tank (9) is arrangeable in such way that a water circulation path from the water tank (9) to the pump (6), from the pump (6) to the water conduit tubing (4), from the water conduit tubing (4) to the water dispenser (3), and from the water dispenser (4) back to the water tank (9) is provided.

Example 18. A hydrogen generator comprising
a reaction chamber (2),
a means for dispensing water in the reaction chamber (2),
a means for extracting hydrogen from the reaction chamber (2),
a means for supplying water to the means for dispensing water, the means for supplying water comprising a water conduit tubing, which is at least partially arranged inside the chamber,
a means for heating the reaction chamber (2), comprising a current flow path for electric heating of at least one electrically conductive portion of the water conduit tubing,
a means for controlling the hydrogen generation process by controlling the means for supplying water and the means for heating the reaction chamber (2).

Example 19. The hydrogen generator according to example 18, wherein

the means for supplying water further comprises a water pump (6) and the means for heating the reaction chamber (2) further comprises a power supply (8) for providing an electric current through the electrically conductive portion of the water conduit tubing, and wherein

the means for controlling the hydrogen generation process comprises a controller (7) for controlling the pump (pumping rate) (6) and the power supply (electrical current) (8).

Example 20. The hydrogen generator according to examples 18 or 19, wherein the water conduit tubing (4) has a plurality of windings (46), which are located inside the reaction chamber (2).

Example 21. The hydrogen generator according to one of the examples 18 to 20, wherein

the means for dispensing water in the reaction chamber (2) comprises a water supply tubing (3) with a plurality of pores (37).

Example 22. The hydrogen generator according to one of the examples 18 to 21, wherein

the means for extracting hydrogen comprises a hydrogen outlet pipe (22) and a hydrogen collector (5) with a hydrogen collector body (18) having a plurality of pores (38).

Example 23. The hydrogen generator according to one of the examples 18 to 22, wherein

the current flow path comprises at least one current conductive portion of the reaction chamber (2).

Example 24. The hydrogen generator according to one of the examples 18 to 23, wherein

a means for collecting residual water from the water dispenser (4) is provided.

Example 25. A method for generating hydrogen comprising following process steps
supplying water into a reaction chamber (2) containing a filling with a chemical reagent by pumping water into a water supply tubing (3) through a water conduit tubing (4) by a water pump (6),
heating of the water conduit tubing (4) by electric current provided by a power supply (8), the electric current flowing through at least one electrically conductive portion of the water conduit tubing (4),
extracting hydrogen generated in the reaction chamber (2) by means of a hydrogen collector (5) and a hydrogen outlet pipe (22),
controlling the water pumping rate and the electrical current value by means of a controller (7) in accordance with at least one reaction parameter.

Example 26. The method according to example 25, wherein the at least one reaction parameter comprises temperature and/or pressure inside the reaction chamber (2) or in a hydrogen outlet pipe (22).

Example 27. The method according to example 25 or 26, wherein

hydrogen is generated in a hydrolysis reaction between water and the reagent present in the filling (47) of the reaction chamber (2).

Example 28. The method according to one of the examples 25 to 27, wherein

the method further comprises determining of a current hydrogen demand by a feedback signal from a hydrogen consumer and controlling the pumping rate and electric current in accordance with the current hydrogen demand.

Example 29. The method according to one of the examples 25 to 28, wherein

the temperature inside the reaction chamber (2) is increased by ohmic heating of the water conduit tubing (4) caused by electric current passing through the water conduit tubing (4) while the said water conduit tubing (4) aiding in the transportation of the water when the electrical current flows from a first output contact (25) of the power supply (8) over the water conduit tubing (4) to the water supply tubing (3) and from the water supply tubing (3) to a second output contact (26) of the power supply (8) over at least one electrically conductive portion of the reaction chamber (2).

Example 30. The method according to one of the examples 25 to 29, wherein

in a warm-up phase of the hydrogen generation process, the supply water (28) from the water tank (9) is pumped into the water supply tubing (3) by pumping the water into the water conduit tubing (4) connected to the water supply tubing (3) while the electric current from the power supply (8) is switched on.

Example 31. The method according to example 30, wherein after the warm-up phase of the hydrogen generation process, the electric current is reduced or switched off by the controller (7).

Example 32. A method for generating hydrogen, comprising steps of
supplying water to a reaction chamber (2),
generating hydrogen in a chemical reaction taking place between water and a chemical reagent included in a filling (47) of the reaction chamber (2),
heating the reaction chamber (2) by electrical heating of a water conduit tubing (4), which is in a thermal contact with the reaction chamber (2) through which water is supplied to a water dispenser (3),
collecting hydrogen in a hydrogen collector (5),
controlling the hydrogen generation process by controlling the water supply through the water conduit tubing (4) and by controlling the electrical heating of the water conduit tubing (4).

Example 33. The method according to example 32, wherein the step of controlling the water supply comprises a step of controlling a pumping rate of a water pump (8) by means of a controller, wherein the pump is pumping water into the water conduit tubing (4), which is connected to the water dispenser (3).

Example 34. The method according to one of the examples 32 or 33, wherein

at least one portion of the water conduit tubing is electrically conductive and the step of controlling of the heating comprises controlling of a power supply providing the electrical current for ohmic heating, the electric current flowing through the electrically conductive portion of the water conduit tubing (4) while the said water conduit tubing facilitating the transportation of the water during the heating of the water.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

### REFERENCE NUMERALS

1 hydrogen generator
1A hydrogen generator
1B hydrogen generator
1C hydrogen generator
1D hydrogen generator
1E hydrogen generator
1F hydrogen generator
1′ cartridge module
2 reaction chamber
2-1 cylindrical body
2-2 flat plate
3 water supply tubing
4 water conduit tubing
5 hydrogen collector
6 pump
7 controller
8 power supply
9 water tank
10 side wall
11 bottom
12 cover
13 tubular body of the water supply tubing
14 first end of the tubular body of the water supply tubing
15 second end of the tubular body of the water supply tubing
16 top cap of the water supply tubing
17 bottom cap of the water supply tubing
18 tubular body of the hydrogen collector
19 first end of the tubular body of the hydrogen collector lector
20 second end of the tubular body of the hydrogen collector lector
21 top cap of the hydrogen collector
22 hydrogen outlet pipe
23 water inlet of the pump
24 water outlet of the pump
25 first output contact of the power supply
26 second output contact of the power supply
27 control input of the power supply
28 supply water
29 water inlet of the tank
30 water outlet of the tank
31 first opening
32 second opening
33 third opening
34 wall of the tubular body of the water supply tubing
35 wall of the tubular body of the hydrogen collector
36 insulator ring
37 pore in the wall of the tubular body of the water supply tubing
38 pore in the wall of the tubular body of the hydrogen collector
39 water tank pipe
40 water supply pipe
41 power supply control line
42 pump control line
43 first electric conduit
44 second electric conduit
46 winding
47 filling
48 upper face of the side wall
49 inner surface of the cover plate
50 first end of the water conduit tubing
51 second end of the water conduit tubing
52 contact on the water conduit tubing
53 contact of the out surface of the bottom
54 cover plate
55 cover ring
56 outer surface of the side wall
57 outer surface of the wall of the tubular body of the water supply tubing
58 inner surface of the wall of the tubular body of the water supply tubing
59 outer surface of the wall of the tubular body of the hydrogen collector
60 inner surface of the wall of the tubular body of the hydrogen collector
65 water dispenser
68 water dispenser heater
70 fan
80 energy power supply device
80A energy power supply device
80B energy power supply device
80C energy power supply device
80I energy power supply device
84 fuel cell module
86 electrical load
88 temperature sensor
89 pressure sensor
90 cooling coil
90B fan
92 buffer tank
92A water level sensor
92B water outlet valve
94 impurity filter
97 supply water cum buffer tank
100 connector
103 connector
105 fan
108 drone
111 housing
114 opening
116 reaction chamber housing
117 fuel cell module casing
118 base plate
119 water tank housing
120 cartridge plunger
125 cartridge housing
D1 outer diameter of the tubular body of the water supply tubing
d1 pore diameter of the tubular body of the water supply tubing
h1 thickness of the wall of the tubular body of the water supply tubing
D2 outer diameter of the tubular body of the water supply tubing
d2 pore diameter
h2 thickness of the wall of the tubular body of the water supply tubing

1. A hydrogen generator comprising:
a reaction chamber configured to contain a reagent,
a supply water tank,
a water conduit tubing provided inside the reaction chamber, the water conduit tubing comprising a water conduit tubing inlet being fluidically connected to the supply water tank and a water conduit tubing outlet,
a water dispenser provided inside the reaction chamber, the water dispenser comprising a water dispenser inlet being fluidically connected to the water conduit tubing outlet and a surface with a plurality of water outlet channels,
a water pump,
an electric power supply,
a controller adapted to activate the water pump for transferring water from the supply water tank, to the water conduit tubing, to the water dispenser, and to the reaction chamber for interacting with the reagent in the reaction chamber to generate hydrogen gas, and
a hydrogen collector provided inside the reaction chamber, the hydrogen collector comprising a surface with a plurality of gas inlet channels for receiving the hydrogen gas.

2. The hydrogen generator according to claim 1, wherein at least one portion of the reaction chamber is electrically conductive, and the electrical current flows through the at least one portion of the reaction chamber.

3. The hydrogen generator of claim 1,
wherein
the water dispenser further comprises a heater configured to heat water in the water dispenser.

4. The hydrogen generator according to claim 1, wherein
the water conduit tubing comprises a coiled tube that surrounds the water dispenser.

5. The hydrogen generator according to claim 1, wherein
the hydrogen generator comprises a plurality of water dispensers.

6. The hydrogen generator according to claim 1, wherein
the hydrogen generator comprises a plurality of hydrogen collectors.

7. The hydrogen generator according to claim 6, wherein each hydrogen collector of the plurality of hydrogen collectors is provided symmetrically around a corresponding water dispenser of a plurality of water dispensers of the hydrogen generator.

8. The hydrogen generator according to claim 1, further comprising
a pressure sensor configured to measure a pressure of hydrogen gas,
a temperature sensor configured to measure a temperature in the reaction chamber,
wherein the controller is further adapted to activate the water pump according to a measurement of the temperature sensor and to regulate pump rate of the water pump according to a measurement of the pressure sensor.

9. The hydrogen generator according to claim 1, wherein
the reaction chamber comprises a housing comprising a thermal insulating material.

10. The hydrogen generator according to claim 1, wherein
the reaction chamber comprises a housing comprising a thermal conductive material.

11. The hydrogen generator according to claim 1, wherein
the reaction chamber comprises a housing with a doughnut shape.

12. The hydrogen generator according to claim 11, wherein the reaction chamber comprises a fan provided in a central hollow part of the doughnut shape of the housing.

13. An energy power supply device comprising
a hydrogen generator according to claim 1, the hydrogen generator further comprising
a cooling coil for receiving hydrogen gas from the reaction chamber, the cooling coil configured to reduce a temperature of the hydrogen gas, and
a buffer tank for separating the hydrogen gas from any water that is mixed with the hydrogen gas, and
a fuel cell module configured to convert the hydrogen gas to electrical energy.

14. An energy power supply device comprising:
a hydrogen generator comprising:
a supply water tank,
a reaction chamber, and
a water pump for transferring water from the supply water tank to the reaction chamber, wherein the reaction chamber is provided to contain a reagent for interacting with the water to generate hydrogen gas,
the hydrogen generator further comprising:
a cooling coil for receiving the hydrogen gas from the reaction chamber and for reducing temperature of the hydrogen gas, and
a buffer tank for separating the hydrogen gas from any water that is mixed with the hydrogen gas, and
a fuel cell module for converting the hydrogen gas to electrical energy,
wherein the energy power supply device further comprises at least one of the following:
an impurity filter configured to remove impurity from the hydrogen gas;
a fan configured to reduce a temperature of one of the cooling coil and the fuel cell module;
a connector removably attaching the fuel cell module to the hydrogen generator;
a connector removably attaching the supply water tank to the reaction chamber;
a housing enclosing the hydrogen generator and the fuel cell module, the housing comprising at least one opening for drawing external air into the housing for cooling at least one of the cooling coil and the reaction chamber; and
a single integrated tank comprising both the buffer tank and the supply water tank.

15-16. (canceled)

17. An energy power supply device comprising
a hydrogen generator comprising
a supply water tank,
a reaction chamber, and
a water pump for transferring water from the supply water tank to the reaction chamber, wherein the reaction chamber is provided to contain a reagent for interacting with the water to generate hydrogen gas,
the hydrogen generator further comprising
a cooling coil for receiving the hydrogen gas from the reaction chamber and for reducing temperature of the hydrogen gas, and
a buffer tank for separating the hydrogen gas from any water that is mixed with the hydrogen gas, and
a fuel cell module for converting the hydrogen gas to electrical energy,
wherein at least one of the cooling coil, the buffer tank, and the water pump are provided inside the supply water tank.

18-19. (canceled)

20. The energy power supply device according to claim 14, further comprising the connector, the connector comprising a press-fit connector.

21. The energy power supply device according to claim 20, wherein the press-fit connector comprises at least one insertion member and at least one receiving member for attaching to the at least one insertion member.

22. The energy power supply device according to claim 21, wherein the at least one insertion member is removably attached to one of the fuel cell module and the hydrogen generator and the at least one receiving member is removably attached to the other of the fuel cell module and hydrogen generator.

23. (canceled)

24. The energy power supply device according to claim 21, wherein the at least one insertion member further comprises a channel for transmission of hydrogen gas from the hydrogen generator to the fuel cell module.

25-27. (canceled)

28. The hydrogen generator of claim 1, wherein:
the water conduit tubing further comprises an electrically conductive material; and
the controller is further adapted to activate the electric power supply, the electric power supply configured to provide an electric current to the water conduit tubing, the water conduit tubing configured to heat and thereby increase a temperature of water in the water conduit tubing and the reagent.
